(19) United States
(12) Patent Application Publication
(10) Pub. No.: US 2009/0192858 A1
(43) Pub. Date: Jul. 30, 2009

(54) Coordination And Management Of Operational Activities Subject to Uncertainty

(75) Inventor: Blake Johnson, Del Mar, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Blake Johnson, Del Mar, CA (US)

(21) Appl. No.: 12/020,996

(22) Filed: Jan. 28, 2008

(51) Int. Cl. G06F 17/00

(52) U.S. Cl. 705/8

(57) ABSTRACT

Operational activities of an enterprise are managed by producing a data record comprising a contingent performance deliverable (CPD) that specifies a set of rights and obligations for two or more parties to the CPD with respect to operational activities of the parties to the CPD, wherein the rights and obligations are defined over a set of uncertain potential future events (SPFE). The CPD is processed to provide an evaluation of likely result of the specified rights and obligations of the parties to the CPD with respect to operational activities of at least one organizational entity comprising an analysis entity, and with respect to sources of uncertainty related to the operational activities of the analysis entity over the SPFE. An output report is generated in accordance with the evaluation.

### CROSS-REFERENCES TO RELATED APPLICATIONS

This application is related to U.S. patent application entitled “Managing Operational Activities When Contingent Performance Deliverables are in Place” by Blake Johnson, filed concurrently with the present application. The disclosure of the related application is incorporated herein in its entirety.

### BACKGROUND

There are many situations in which two or more parties may wish to assess the impact of uncertain future events on their respective activities, where those respective activities have some mutual effect on each other. One such situation involves management of operational activities between groups within a company or firm, such as where a sales department and production department must determine planning requirements in view of uncertainty about sales and production demands in the coming year. The terms of such requirements can be difficult to appropriately assess and analyze due to the uncertain nature of relevant future events. Another such situation could involve specification of a supply agreement between one firm and an external partner, in which the firm and partner will negotiate demand and delivery terms between them subject to uncertainty about future supply and/or demand. Another such situation could relate to a licensing agreement between two or more parties, where the terms of the agreement will depend on uncertain future levels of production or sales of products subject to the licensing agreement. Such operational management and multiparty coordination scenarios can be quite difficult to generate and assess in the presence of uncertainty, but would be made more convenient with suitable analysis and documentation tools.

More specifically, the coordination and management of operational activities within a firm and with external partners of the firm in the presence of uncertainty is complex due to two principal reasons: Individual operational activities are complex, and important interdependencies exist between activities. Both are described in more detail below.

Individual Operational Activities are Complex

Management of individual operational activities within a firm, such as manufacturing, product design, sales and marketing, procurement, information technology, logistics, distribution, and facilities management requires the management and coordination of many specific tasks and activities. In almost all cases performance of these tasks and activities is further complicated by the presence of multiple sources of uncertainty. For example, manufacturing yields may be uncertain, sales and procurement may be exposed to uncertain and fluctuating demand and supply, and distribution may be disrupted by weather or transportation delays.

Firms attempt to address these challenges by hiring experienced management teams and investing in specialized resources, such as software systems, to facilitate the management of each such operational activity.

Important Interdependencies Exist Between Activities

In addition to the complexity of managing individual operational activities, management of the overall operational activities of a firm is further complicated by the important operational interdependencies that exist between operational activities, and which make effective coordination and management across activities essential.

For example, the production requirements that manufacturing must meet depend on the specific and uncertain quantities and types of products which sales is able to sell and customers demand. Similarly, uncertainty about the future design of products, and where and when manufacturing will decide to build them, determines the uncertain raw material requirements procurement and suppliers must meet, and the uncertain transportation and distribution requirements logistics and supply chain must meet.

As a result of these interdependencies, managers of individual activities must 1) monitor events in related activities, both within and external to the firm, which may impact them, 2) communicate events in their areas of responsibility which may impact others, and 3) work with managers of the other activities, both within and external to their firm, to coordinate the management of their respective activities. In almost all cases such communication and coordination is made more complex by the presence of multiple sources of uncertainty, both about the individual activities and about their interdependencies. For example, uncertainty about and revisions to the current or prospective sales in the example above may lead to changes in a firm's manufacturing, raw material, and logistics and distribution activities.

Together the complexity of individual operational activities conducted within a firm and by its external partners, and the interdependencies that exist between those activities, make the scope and complexity of the problem of managing the overall operational activities of a firm very large.

Firms Break the Overall Management of Their Operational Activities into Sub-Problems

Due to scale and complexity of the overall operational activities of the firm, it is standard practice in nearly all firms to 1) break the activities down into subsets, and assign each to a business unit, team, or functional unit (hereafter an “organizational entity”) to manage, and 2) establish organizational processes for coordinating and managing operational interdependencies across these subsets of activities and the organizational entities responsible for them.

The operational management scenarios described above apply to multiparty coordination scenarios, as well as inter-firm coordination and management scenarios. The tasks associated with generating suitable agreements that set forth the rights and obligations of the parties to such agreements can be unwieldy. The management, documentation, and analysis tasks would be more convenient if suitable tools and resources were available.

### SUMMARY

In accordance with the invention, operational activities are coordinated and managed across organizational entities by utilizing Contingent Performance Deliverables (CPDs). The operational activities of an enterprise are managed with a computer system that produces a data record comprising a contingent performance deliverable (CPD) that specifies a set of rights and obligations for two or more parties to the CPD with respect to operational activities of the parties to the CPD, wherein the rights and obligations are defined over a set of uncertain potential future events (SPFE). The CPD data record is processed to provide an output comprising an evaluation of likely result of the specified rights and obligations of the parties to the CPD over the SPFE, with respect to operational activities of at least one organizational entity comprising an analysis entity, and with respect to sources of uncertainty related to the operational activities of the parties to the CPD or the analysis entity. The one or more analysis entities may be parties to the CPD, or may be different organizational entities.

An output report is generated from the evaluation output.

The operational activities, rights and obligations, and SPFE sets can be defined in accordance with user input, default values, or probability distribution functions, or any combination. The system can access existing CPDs stored in the computer system to obtain data for current CPDs being produced or to use as input functions for the current CPDs being produced. The evaluation output can comprise an evaluation of the likely result of the specified rights and obligations of the parties to the CPD on one or more performance metrics of at least one analysis entity.

The CPDs are generally shared between organizational entities, and used to efficiently and effectively coordinate and manage operational activities across organizational entities within a firm, and between organizational entities within a firm and with relevant external partners.

As described further below, a CPD comprises a data record that specifies an agreement concerning operational activities between parties over a set of potential future events (a “SPFE”) which specifies at least one right and at least one obligation for each party. The SPFE is defined over a time period and over a range of uncertainties relative to the operational activities. For example, the operational activities may involve sales of products in units and selling prices set for each of the units. A variety of rights and obligations may be specified in the CPD. The systems and methods described herein help facilitate creation, management, and execution of the CPDs and provide a means for parties to exchange information and cooperatively generate, execute, and monitor CPDs.

Other features and advantages of the present invention should be apparent from the following description of the preferred embodiments, which illustrate, by way of example, the principles of the invention.

### BRIEF DESCRIPTION OF THE DRAWINGS

FIG. 1 is a flow diagram of operations performed in accordance with the invention for parties to generate CPDs in the coordination and management of operational activities across organizational entities.

FIG. 2 is an illustration of output produced according to the operations depicted in FIG. 1 for operational activities involving sourcing.

FIGS. 3 and 4 are flow diagrams of operations performed in accordance with the invention for parties to generate CPDs in the coordination and management of operational activities across organizational entities.

FIG. 5 is an exemplary output report produced by a system constructed according to the present invention.

FIGS. 6 through 10 are flow diagrams of operations performed in accordance with the invention for parties to generate CPDs in the coordination and management of operational activities across organizational entities.

FIG. 11 is a representation of output produced by a system constructed according to the present invention.

FIGS. 12, 13, and 14 are flow diagrams of operations performed in accordance with the invention for parties to generate CPDs in the coordination and management of operational activities across organizational entities.

FIG. 15 is a representation of output produced by a system constructed according to the present invention.

FIGS. 16 and 17 are flow diagrams of operations performed in accordance with the invention for parties to generate CPDs in the coordination and management of operational activities across organizational entities.

FIG. 18 is a block diagram of a system constructed in accordance with the invention to perform the operations and produce the output reports illustrated in FIG. 1 through FIG. 17.

### DETAILED DESCRIPTION

The remainder of this specification is made up of three sections. The first section defines CPDs, summarizes the benefits of their use in the coordination and management of operational activities across organizational entities within a firm and with external partners in the presence of uncertainty, and describes how such CPD-based methods differ from other methods currently in use. The second section presents systems and methods to enable CPDs to be utilized efficiently and effectively for this purpose. The third section describes systems and methods for using the techniques described herein.

I. Contingent Performance Deliverables

This section defines the term Contingent Performance Deliverable (“CPD”) and describes why CPDs are useful in coordinating and managing operational activities across organizational entities within a firm, and with relevant external partners. It also describes how CPD-based methods differ from existing methods of coordinating and managing such activities.

A. Definition of Contingent Performance Deliverable (“CPD”)

Definition: A Contingent Performance Deliverable (“CPD”) is an agreement governing operational activities between parties over a set of uncertain potential future events (a “SPFE”) which specifies at least one right and at least one obligation for each party.

It is useful to highlight several important distinctions made in the definition of CPDs. First, CPDs address operational activities, and therefore differ from financial arrangements or agreements, including incentive, compensation, and performance management agreements. Second, CPDs specify at least one right and at least one obligation for each party. Third, the rights and obligations of a CPD are specified over a set of uncertain potential future events, or SPFE. The importance and business role of each of these distinctions are described below. First two representative examples are provided.

CPDs with Explicitly Defined SPFEs

When the SPFE of a CPD is defined over sources of uncertainty with outcomes that are observable and verifiable by the counterparties of the CPD, the SPFE may be defined explicitly based on the future outcomes of these sources of uncertainty.

For example, consider a manufacturing organization that builds a product sold by a sales organization. Assume that the future price of a key manufacturing input is uncertain, as is the quantity of the product the sales organization will sell during the future period. If the future price paid for the manufacturing input and quantity of the product sold are observable and verifiable by both organizations, potential future values of each can be used to define the SPFE of a CPD. Rights and obligations can then be defined over this SPFE, such as price and quantity terms for the product to be delivered to sales by manufacturing. A simple but representative CPD of this form between the manufacturing and sales organizations is shown in Table 1.

In Table 1, the rows of the table relate to customer demand and the columns of the table relate to supply cost. The SPFE with respect to supply cost is divided into sets or intervals comprising less than $1 for the supply cost, greater than or equal to $1 and less than $2 for the cost, and greater than or equal to $2. The SPFE with respect to customer demand is specified as intervals comprising less than 100 units demanded (sold or delivered), greater than or equal to 100 and less than 150 units, greater than or equal to 150 and less than 200, and greater than or equal to 200. The complete SPFE is defined by the pairs of these values, as represented by the cells in Table 1. For example, the cell in the upper right hand corner of Table 1 represents the potential future event that the input price (supply cost) is greater than or equal to $2 and customer demand is less than 100 units.

The CPD specifies rights and obligations of the manufacturing and sales organizations over the SPFE of the CPD. The rights and obligations for a specific event in the SPFE are listed in the cell in the table corresponding to that event. Thus, for a potential future event in which the supply cost is less than $1 and customer demand is between 100 and 150, Table 1 shows that the manufacturing organization agrees to provide finished goods at a price of $7.50 (P=$7.50), and the sales organization agrees to purchase (i.e., ship) between 100 and 150 units (100≦Q<150).

TABLE 1
Sample CPD terms

| | | Price of key input | | |
|---|---|---|---|---|
| | | <$1 | $1 < $2 | $2< |
| Customer | <100 | P = $7.00 | P = $7.75 | P = $8.50 |
| demand | | Q = 125 | Q = 110 | Q = 100 |
| | 100-150 | P = $7.50 | P = $8.25 | P = $9.25 |
| | | 100 < Q < 150 | 100 < Q < 150 | 100 < Q < 150 |
| | 150-200 | P = $7.75 | P = $8.75 | P = $9.75 |
| | | 150 < Q < 200 | 150 < Q < 200 | 150 < Q < 200 |
| | 200+ | P = $8.00 | P = $9.25 | P = $10.50 |
| | | Q = 200 | Q = 200 | Q = 200 |

Table 1 shows that the SPFE of the CPD may be specified using one or more probability distribution functions. For example, the intervals shown in Table 1 for the price of the key input may be generated from a probability distribution for the key input price. As one example, assume that the range of a probability distribution function for the key input price is from $0.75 to $2.50, and this range has been divided into intervals of less than $1, greater than or equal to $1 and less than $2, and greater than or equal to $2 based on the relatively likelihood of these intervals. These intervals are the column headings in Table 1. A similar approach may be used to generate the intervals for customer demand shown in Table 1 from a probability distribution for customer demand. In this case, the intervals for the key input price and customer demand together define the set of future events that have a possibility of occurring, and probabilities can be calculated for each such event from the joint probability distributions of the key input price and customer demand. As described below, the system supports a variety of different techniques for determining SPFEs in this manner, and for providing data relating to the SPFE values determined, such as their probabilities of occurrence.

Table 1 also shows that the CPD specifies both an input and an output of the operational activities. For example, the operational activities related to the CPD shown in Table 1 involve procurement, manufacturing, and sales. In the case of manufacturing, the output price (price of units=P) is a function of the price of supplies (the key input cost) and number of units demanded by customers of the firm. In the case of sales, rights and obligations concerning the price and number of units to be supplied by manufacturing are a function of customer demand and the key input price. Thus, the CPD specifies rights and obligations of the parties in terms of both inputs and outputs of the organizational activities to which the CPD relates.

In the more general case a CPD and its SPFE may be specified over multiple time periods and over any number of sources of uncertainty. For example, a CPD might contain Table 1 for an initial time period (e.g., for the next six months) and the same CPD might contain additional tables with similar information, except that the additional tables would contain data for different time periods (e.g., up to one year from now, one to two years, and so forth). In addition, a wide range of different types of rights and obligations may be specified, and more than two counterparties may be involved.

While the relatively simple sample CPD above can be represented in a two dimensional table, more general CPDs with explicitly defined SPFEs can be represented by a list that provides a definition of each event of the SPFE, and for each event specifies additional data fields that define the rights and obligations of each of the counterparties to the CPD under that event.

CPDs with Implicitly Defined SPFEs

In some cases the outcomes of one or more of the sources of uncertainty relevant to a CPD may not be observable and verifiable by all of the counterparties to the CPD. When this is true events in the SPFE that depend on these one or more sources of uncertainty may be defined implicitly, rather than explicitly.

For instance, in the example above the buyer may be either unwilling or unable to disclose the volume of its sales to its customers. As a result, rather than defining relevant events in the SPFE based on these future sales to customers, the events may be defined based on purchases by the sales team under the CPD, subject to the sales team's rights and obligations under the CPD.

For example, the sales team might agree to an obligation to buy at least 100 units of the product in return for a right to buy up to 200 units of the product. The SPFE of the CPD may then include events defined by the number of units of the product the sales team actually chooses to buy during the relevant future period, for example between 100 and 125 units, 126 and 150 units, 151 and 175 units, and 176 and 200 units. Other rights and obligations of both the sales team and the manufacturing organization may then be defined over these potential future events. An example is shown in Table 2 below.

TABLE 2
Sample CPD terms

| | | Price of key input | | |
|---|---|---|---|---|
| | | <$1 | $1 < $2 | $2< |
| Sales team | 100-125 | P = $7.00 | P = $7.75 | P = $8.50 |
| purchases | | 100 < Q < 125 | 100 < Q < 125 | 100 < Q < 125 |
| | 125-150 | P = $7.50 | P = $8.25 | P = $9.25 |
| | | 126 < Q < 150 | 126 < Q < 150 | 126 < Q < 150 |
| | 150-175 | P = $7.75 | P = $8.75 | P = $9.75 |
| | | 151 < Q < 175 | 151 < Q < 175 | 151 < Q < 175 |
| | 175-200 | P = $8.00 | P = $9.25 | P = $10.50 |
| | | 176 < Q < 200 | 176 < Q < 200 | 176 < Q < 200 |

Performance to the Terms of CPDs

A wide range of methods may be used to ensure that the counterparties to a CPD honor their rights and obligations under the CPD. Depending on the organizational context and relationship between the counterparties of a CPD, performance may be agreed to verbally and on good faith, as may be appropriate for two organizational entities within the same firm that have a close working relationship. Alternatively, counterparties in different firms that have an adversarial relationship and little trust or faith in the other's behavior may specify penalties or incentives in fully documented and legally binding agreements. Thus the differentiating characteristic of a CPD is its specification of both rights and obligations of its counterparties over its SPFE. Terms added to CPDs to ensure counterparty performance to those rights and obligations function as enablers of these differentiating characteristics.

B. Benefits of Using CPDs to Coordinate and Manage Operational Activities Subject to Uncertainty Across Organizational Entities Within a Firm and with External Partners

The rights and obligation of a CPD define, over a set of potential future events (SPFE), what each party to the CPD may:
Request of the other
Be called upon to deliver to the other

The rationale for and value of using CPDs to coordinate and manage operational activities across organizational entities is that CPDs provide a minimum sufficient basis for effective management and coordination between entities when uncertainty is present. Specifically, CPDs specify the rights and obligations of each entity over potential outcomes of relevant sources of uncertainty. They do not, however, attempt to specify either the “how” by which each entity plans to meet its obligations under the CPD, or the “why” of how a CPD may align with an entity's goals, resources and capabilities, or other alternatives or obligations.

By defining only the “what” of the relationship between the entities, CPDs facilitate coordination and management of a firm's overall activities by enabling each organizational entity to focus only on managing the subset of the firm's activities it is responsible for. Individual entities do not need to understand or involve themselves in the activities of other entities, including the “how” by which an entity plans to perform to a CPD or the “why” that may lead it to prefer one CPD over another. In addition, because CPDs are defined over a set of potential future events (SPFE), they allow their counterparties to identify, proactively plan for, and manage sources of uncertainty relevant to their activities, coordination, and performance.

A range of examples of how CPDs may be used between organizational entities are provided below.

C. How CPDs Differ from Existing Methods of Coordinating and Managing Operational Activities Across Organizational Entities

I. Forecasts

The most common method for coordinating operational activities across organizational entities within a firm, and with external partners, is the sharing of forecasts. For example, a sales team may share its forecast with a manufacturing and a procurement team to enable those teams to appropriately plan their activities in order to meet future sales, and the procurement team may share the forecast provided with relevant external suppliers. In some cases “forecast scenarios” or “range forecasts” are shared between organizational entities to communicate uncertainty about the forecast.

Forecasts, including range forecasts, differ fundamentally from CPDs because they do not specify rights and obligations for each relevant organizational entity across a SPFE. By defining rights and obligations for each party over a SPFE, CPDs enable much more efficient and effective coordination, as illustrated by the example below.

### EXAMPLE

### Forecast Gaming and Distortion

A widely recognized weakness of using forecasts for operational coordination between entities is that forecasts may be biased or distorted by one or more entities in an effort to influence the actions of others to their advantage. For example, a sales team which seeks to ensure that a sufficient supply of a product will be available in the future should future customer demand prove high may forecast a higher level of future demand than it actually expects. The use of “range” forecasts does not eliminate this problem, since a sales team may also distort the high scenarios of a range forecast to increase future product availability, and/or distort the low scenarios of the range forecast to reduce its potential responsibility for unsold inventory in the event that future demand is low.

CPDs mitigate these weaknesses by defining the rights and obligations of each party over a SPFE. For example, under a CPD a sales organization may commit to sell at least a small quantity of a product (an obligation which will be relevant under the potential future event of low demand), and may request assured access to a larger quantity of the product (a right which will be relevant under the potential future event of high demand).

These rights and obligations of the sales organization create corresponding rights and obligations for its counterparty under the CPD, which for example may be a manufacturing or supply chain team within the same firm. Specifically, such a counterparty will gain the right to hold sales responsible for a portion of its production or inventory if actual demand turns out to be below the minimum level sales has committed to, and to be absolved of responsibility for supplying product above the maximum quantity sales has requested assured access to. In exchange for these rights, the counterparty assumes the obligation to provide any quantity of the product between the upper and lower bounds defined by the CPD which sales may request over the future period covered by the CPD, and to bear the associated costs and risks.

2. Collaboration

A second common method of coordinating operational activities across organizational entities is “collaboration”. Broadly defined, collaboration refers to efforts by two or more organizational entities to jointly identify, evaluate, and implement alternatives for managing operational activities across their respective areas of responsibility.

Because collaboration is based on the joint assessment and execution of alternatives for operational activities across organizational entities, it differs fundamentally from CPD-based methods of coordination across organizational entities. Specifically, in contrast to collaboration, under CPD-based coordination each organizational entity maintains responsibility for its own activities, and uses CPDs to manage the interactions and interdependencies between those activities and the operational activities of other organizational entities.

### EXAMPLE

By nature collaboration requires organizational entities to share and to jointly assess the “how” and “why” of activities within their individual areas of responsibility. Such joint or collaborative management of a broader scope of operational activities generally results in significant analytic and organizational complexities.

For example, under a collaborative approach to the problem of operational coordination between the sales and supply chain organizations described above, sales may share information about prospective sales with supply chain, and supply chain may share information about its ability to vary production in response to fluctuations in customer demand with the sales team. The two groups may then jointly assess alternatives for sales strategy and supply chain planning and execution, including the cost, risk, and relative ability of alternative supply chain strategies to accommodate uncertainty about future sales.

In contrast, under CPD-based coordination supply chain may offer several different prospective CPDs to sales, each of which provide different levels of product availability and cost across potential outcomes of future sales. In response, sales might respond with CPD terms under which it commits to specific levels of minimum or maximum sales, delivery lead times, and sharing of supply chain costs or risks.

3. Compensation, Incentive, and Performance Management Agreements

Many firms use compensation, incentive, or performance management agreements which define compensation or financial incentives over potential future events. Common examples include incentives for sales staff that specify their future compensation as a function of the actual level of sales they achieve in future periods. Similar agreements are also sometimes used for other activities, such as manufacturing output, cost reduction, or customer satisfaction.

Contingent incentive, compensation, or performance management agreements between organizational entities differ from CPDs because they define financial rights and obligations, rather than rights and obligations for operational activities. In most cases they also do not define both rights and obligations for each party, but rather obligations for one (e.g. the manager providing the incentive) and rights for the other (e.g. the sales person that will be paid commission based on future sales). These differences, and the opportunity they leave to generate additional value with CPDs, are evident in problems that occur regularly in sales management today, as illustrated in the example below.

### EXAMPLE

Sales teams with incentive compensation plans often find that the products their customers want, and which they can therefore easily sell, are in short supply, while products which customers do not want are readily available. As a result, the sales teams are often unable to “make their numbers”, and therefore unable to earn the incentive compensation they feel they deserve. Similarly, supply chain teams often find that the forecasts sales teams provide are incorrect, and that as a result they have built too many of the “wrong” products and not enough of the “right” products. To attempt to correct this imbalance supply chain must incur additional cost, for example from expediting and overtime, and by incurring these costs may fail to earn the performance-based bonuses it feels it deserves.

In situations such as these, sales teams often state that they wish supply chain could be held accountable for providing the “right” mix and volume of products, and supply chain teams often state that they wish sales could be held accountable for selling the mix and volume of products it has forecast.

As these comments reflect, a key part of the problem is thus the need for operational coordination and management between the sales and supply chain teams. This need is not met by current financial incentive, compensation, and performance management agreements, as this example illustrates.

4. What-Ifs and Scenario Planning

“What-ifs” and “scenario planning” address planning under uncertainty. For example, what-if scenarios are commonly run for alternative forecasts to see how appropriate plans for a specific set of activities vary as the forecast varies. Similarly, scenario planning is used to develop plans for alternative scenarios for future events, and to compare the performance and risk exposures of prospective plans across such scenarios.

In many cases the scenarios and plans evaluated with scenario planning span many activities. A common example is the use of scenario planning in a company's strategic planning activities. Due to the complexity of joint planning across many activities, scenario plans are generally high level plans generated on an infrequent basis, rather than plans for operational activities that are created and executed on a day-to-day basis. For a standard reference on scenario planning, see Peter Schwartz, The Art of the Long View, Doubleday, 1991.

Because they address the planning of a specific set of activities, what-ifs and scenario planning processes differ in both focus and role from the CPD-based methods for coordinating and managing operational activities across organizational entities disclosed here. In addition, what-ifs and scenario planning do not define rights and obligations of organizational entities across SPFEs.

### EXAMPLE

Continuing the example above, it is common for supply chain organizations to run “what-if” scenarios to assess alternative plans for their activities over uncertain future events, such as the prospective levels of future sales discussed above. While running what-if scenarios in this way may allow a supply chain organization to better plan its internal activities, it does not provide a method for the supply chain organization to coordinate its activities with those of other organizational entities, such as sales.

Following the same example, some general managers and financial managers also run what-if scenarios, which may include scenarios for both supply chain and sales performance. Such scenarios can allow general or financial managers to quantify how different sales and supply chain performance outcomes will impact overall performance, information which the managers can in turn use to structure performance incentives for the sales organization and for the supply chain organization, such as those discussed above. However, as highlighted above, neither the scenarios nor the performance incentives provide a method for coordinating operational activities and operational interdependencies across the sales and supply chain organizations, a need which is met with CPDs.

5. Stochastic Models

Stochastic models of operational activities within a firm also incorporate uncertainty. However, like what-ifs and scenario planning, stochastic models address the management of a specific set of operational activities, rather than coordination across sets of operational activities managed by different organizational entities.

For example, many stochastic models exist for specific activities within a firm, such as manufacturing, inventory management, procurement, distribution, network design and management, and product pricing and allocation. Stochastic models that jointly model multiple operational activities also exist, such as sourcing and inventory, or capacity, production, and network design. Some models even attempt to model a firm's entire set of operational activities, or the activities of an entire supply chain.

Stochastic models of multiple operational activities clearly enable analysis of alternatives for coordination and management across those activities. However, they do so through joint analysis of the combined set of activities, and therefore differ fundamentally from the CPD-based methods disclosed here for coordination and management across two or more organizational entities, each of which is responsible for managing a subset of the operational activities in question. As discussed above, the complexities associated with the joint analysis and management of multiple operational activities is in fact a primary source of motivation for the CPD-based methods disclosed here. Finally, it is important to note that even if a stochastic model that spans multiple operational activities can be successfully constructed and run, organizational implementation of its results, which requires mapping of the plans it generates for complex and interdependent operational activities to the responsibilities of relevant staff, and provision of the information and incentives necessary for their execution by that staff, is often extremely difficult.

II. Systems and Methods to Facilitate Operational Coordination and Management Across Organizational Entities Using CPDs

As described above, CPDs provide new and unique capabilities that enable improved coordination and management of operational activities between organizational entities within a firm, and with relevant external partners. To efficiently and effectively leverage these capabilities of CPDs, organizational entities require systems and methods to assist them in structuring both the terms of individual CPDs and their overall “portfolio” of CPDs to best meet business objectives, and to utilize, monitor, and update CPDs over time.

A range of such systems and methods are described below.

A. System and Method to Evaluate the Impact of the Terms of One or More Current or Prospective CPDs of an Organizational Entity on its Operational Activities or Other Current or Prospective CPDs

An organizational entity may benefit from the use of a system and method to assess how one or more CPDs, either current or prospective, may impact its operational activities and/or other CPDs. This may include evaluation of the impact of specific terms of the CPDs being assessed, including the terms that define the rights, obligations, or SPFEs of the CPDs. Analysis of this kind is valuable because it enables the organizational entity to structure and select CPDs with rights, obligations and SPFEs with the most beneficial impact.

For example, a manufacturing team may wish to assess how one or more prospective CPDs for raw materials which it may establish will impact its operational activities, its ability to honor its current or prospective CPDs, for example CPDs with one or more sales teams it manufactures products for, or its ability to honor similar relationships where CPDs are not employed.

As a second example, the same manufacturing team may wish to assess how the terms of a prospective CPD which it may establish with a sales team will impact its need for and utilization of its current CPDs for relevant raw materials, or may require it to establish CPDs or other relationships for new or different raw materials.

In many cases organizational entities may also wish to simultaneously evaluate the terms of two or more current or prospective CPDs due to interdependencies between those CPDs. For example, in the first example above the manufacturing team may wish to jointly evaluate CPDs for two or more of the raw materials a product requires if the product can only be built if all necessary materials are available in the required quantities. In a second example, the manufacturing team may wish to evaluate CPDs with two or more sales teams in parallel if the CPDs require the use of the same, limited production capacity or raw material resources. In a third example the manufacturing team may wish to evaluate CPDs for one or more raw materials a product requires jointly with CPDs for the delivery of that product.

Each of these examples highlights the importance of a system and method to support an organizational entity in its efforts to identify the most valuable CPDs by quantifying the impact of CPDs on the operational activities and/or other current or prospective CPDs of the organizational entity. To summarize, CPDs are complex instruments with many parameters, including those which define the SPFE of the CPD, and those which define the rights and obligations of each of the counterparties to the CPD over the SPFE. Similarly, the operational activities of an organizational entity are complex, with many interdependent aspects and dimensions, each of which may be impacted by the one or more CPDs. Thus providing information and analysis which quantifies the impact of one or more CPDs on relevant aspects and dimensions of the operational activities of an organizational entity or its other current or prospective CPDs is challenging but valuable, since this information enables the organizational entity to more efficiently and effectively structure and utilize CPDs with its counterparties.

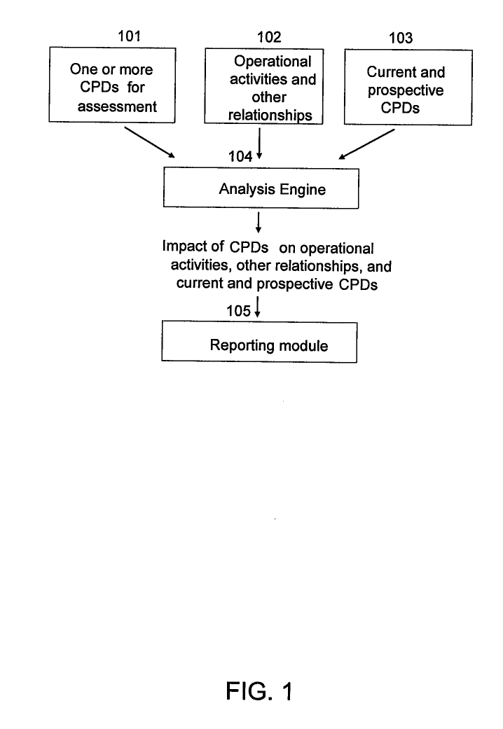

FIG. 1 shows the process steps of a system and method to provide this information about and analysis of the impact of one or more CPDs on the operational activities and other current or prospective CPDs of an organizational entity. In step 101 the one or more current or prospective CPDs to be assessed are entered. In step 102, the operational activities of the organizational entity, including counterparty relationships of the organizational entity where CPDs are not in place, are entered. A wide variety of methods for modeling the operational activities of an organizational entity, including its counterparty relationships where CPDs are not in place, are commonly used in current practice, any of which may be suitable here. In step 103 other current and prospective CPDs of the organizational entity are entered. In step 104 an analysis engine evaluates the impact of the terms of the one or more current or prospective CPDs from step 101 on the operational activities, including counterparty relationship where CPDs are not in place from step 102, and on the other current or prospective CPDs from step 103. See, for example, U.S. patent application entitled “Managing Operational Activities When Contingent Performance Deliverables are in Place” to Blake Johnson, which describes systems and methods that provides these capabilities. In step 105 a reporting module presents results of the analysis engine of step 104. Steps 101, 103, and 105 are described in more detail below.

Steps 101 and 103 require the entry or specification of one or more CPDs. As described above, each CPD is comprised of a set of rights and obligations defined over a SPFE, where the SPFE may be either explicitly or implicitly defined. For each relevant CPD this information may either be entered directly by the user through a suitable user interface, or specified as an upload from one or more existing locations, such as one or more stored databases or spreadsheets.

Step 105 provides the crucial step of communicating the impact of the one or more CPDs on the operational activities of the organizational entity, including counterparty relationships where CPDs are not in place, and/or on other current and prospective CPDs of the organizational entity. Data may be presented through data tables, as well as visual means, such as graphs and charts.

Reports may be configured to provide summary data on the impact of the one or more CPDs on a broad range of operational activities, or about their impact on specific operational activities of particular relevance to individual users within the organizational entity, such as users responsible for those specific activities. Similarly, reports may be configured to provide data on the impact of the CPDs on the organizational entity's overall set of other current or prospective CPDs, or on specific CPDs of interest to particular users.

For each such area of impact it will often be desirable to generate reports which convey the impact of the CPDs under different events of, or subsets of events of, the SPFEs of one or more CPDs. Reports of this kind allow the impact of the rights and obligations of the CPDs under specific events or subsets of events to be quantified and analyzed, and therefore further optimized to provide the greatest benefit. For similar reasons it will also often be desirable to generate reports of the impact of the CPDs across prospective future outcomes of other relevant sources of uncertainty. This information can be used to select the structure and terms of CPDs to optimize that impact, including the risk and flexibility of operational activities.

Finally, in many cases an organizational entity will wish to tailor the reports generated to the characteristics of the CPDs being assessed, and to the business purpose of the reports, including the role and sophistication of their intended audience. More generally, the reporting requirements of different organizational entities will in general differ, due to differences in their activities and objectives.

Each of these aspects of step 105, report generation, can be illustrated by revisiting the examples above. Specifically, in the first example above the manufacturing team may wish to assess the impact of one or more prospective CPDs for raw materials on operational activities, such as inventory buffers for the material, and possibly other related materials, and production activities for products the material is used in. Detailed data on this impact may be reported to inventory or production managers, and more aggregate, summary data to financial or general managers. Both types of users may also wish to see how this impact varies across individual elements or subsets of the SPFE or other relevant sources of uncertainty, which may include high or low demand outcomes, or constrained or unconstrained supply conditions for the material. If this analysis reveals that excess inventory or material shortages occur under certain elements of a SPFE, for example, relevant rights and obligations of the one or more CPDs can be reassessed and the performance of alternative specifications for these rights and obligations evaluated.

In contrast, “customer facing” members of the organizational entity may wish to focus on the impact of the one or more CPDs for raw materials on the ability of the organizational entity to honor its current or prospective CPDs with the one or more sales teams it manufactures products for, or to honor similar relationships where CPDs are not employed. For example, such users of the system may wish to review the impact of CPDs on shipment schedules versus customer orders or similar operational activities. They may also wish to review how these activities vary across relevant sources of uncertainty, for example prospective customer demand levels or product specifications.

To assess the impact of the terms of one or more prospective CPDs for the delivery of products (as opposed to CPDs for the sourcing of raw materials), members of the organizational entity may benefit from quite different reports, where those reports are tailored to the impact areas most relevant to customer delivery commitments. Similarly, organizational entities responsible for activities other than manufacturing will in general benefit from reports tailored to their specific activities, and to the high impact areas of the various CPDs they may utilize.

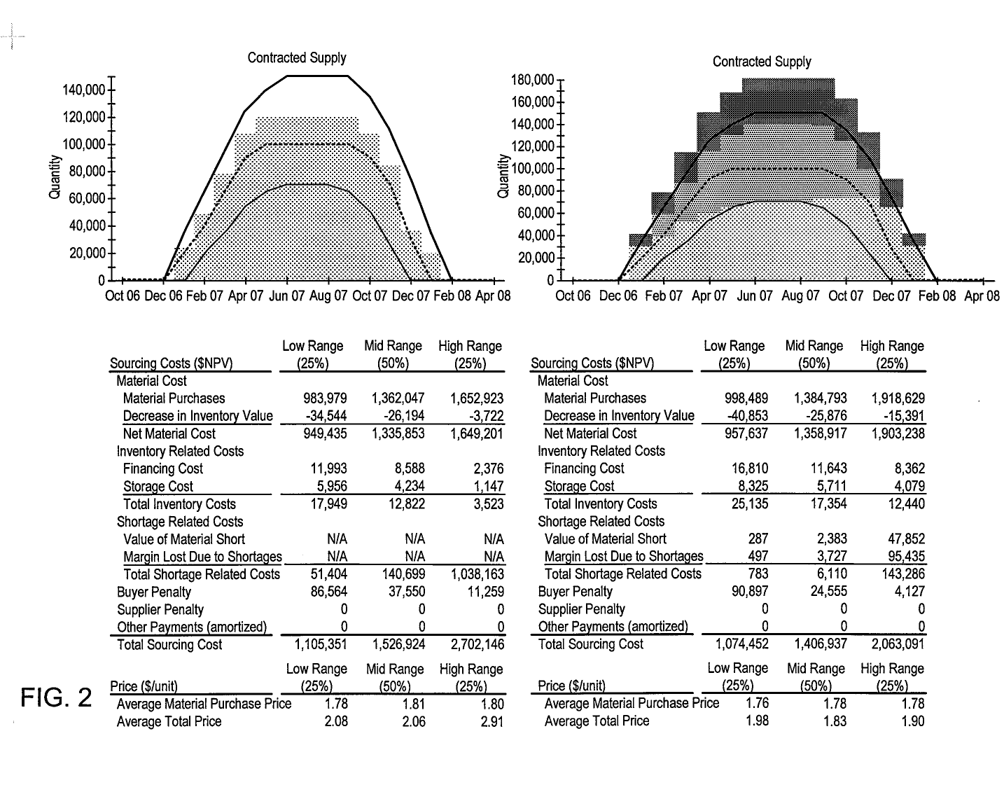

FIG. 2 is a representation of output comprising a sample report produced by the system for operational activities involving sourcing. The FIG. 2 report compares the impact of one sourcing CPD with the impact of a “portfolio” of three other sourcing CPDs. The graphic and table on the left side of the report show the impact of the one sourcing CPD, and the graphic and table on the right side show the impact of the three sourcing CPDs.

Referring first to the graphics at the top of the report, the green, blue, and red lines show the 10th, 50th, and 90th percentiles of the probability distributions for the organizational entity's future demand for the good being sourced, for each of the future periods shown on the horizontal axis of the graphic. The shaded regions in each graphic show the quantity of the good sourced under the CPDs, as determined by the analysis engine based on the rights and obligations of the CPDs. For example, the blue shaded region in the graphic at the top left of the report shows the quantity of the good sourced under the one CPD, while the three different shaded regions in the graphic at the top right of the report show the quantity of the good sourced under each of the three CPDs in the portfolio of three CPDs.

By referring to the graphic the user may compare the impact of the one CPD with the impact of the portfolio of three CPDs on the organization's ability to meet its uncertain future requirements for the good. For example, the quantity of the good available under the rights of the one CPD shown on the left exceeds the 50th percentile of the organization's probability distribution for future demand in each month, but falls below the 90th percentile. In contrast, the combined quantity of the good available under the rights of the three CPDs shown on the left exceeds the 90th percentile in each period. Thus by reviewing the graphics the user may determine that the one CPD and the portfolio of three CPDs have a significantly different impact on the organizational entity's ability to secure a sufficient quantity of the good to meet potential outcomes which may occur at the high end of the probability distributions for its demand in future periods.

Referring next to the tables in the FIG. 2 report, numerical data is shown which compares the impact of the CPDs on several operational variables. For each variable, values are shown across potential outcomes for the organizational entity's future demand for the good. Specifically, each row in the tables shows the values of a specific operational variable, such as material, inventory, or shortage cost, under demand outcomes in the lowest 25% of possible demand outcomes, middle 50% of possible demand outcomes, and highest 25% of possible demand outcomes, as determined from the probability distributions for such demand outcomes. To determine how CPD impact varies across different potential future demand outcomes, which is a key consideration in managing sourcing activities when demand is uncertain, a user may accordingly compare a variable's value across such demand ranges. Further, by reviewing the values of each of the different variables shown in the table, the user may assess how CPD impact varies across key impact areas. Thus by comparing the values in the two tables, a user may determine whether the one CPD or the portfolio of three CPDs has the most beneficial overall impact. In addition, the user may determine areas for improvement in the impact of either or both the one CPD and the portfolio of three CPDs, assess trade-offs in impact across different variables and demand outcomes, and conduct other similar analyses.

B. System and Method to Evaluate the Impact of the Terms of One or More Current or Prospective CPDs of an Organizational Entity on One or More Performance Metrics for the Entity

To assess the relative merits of alternative CPDs, an organizational entity may also benefit from a system and method that enables it to assess how one or more CPDs, either current or prospective, impact one or more metrics for its future performance. For example, the manufacturing team in the example above may wish to evaluate the impact of alternative CPDs for raw materials, including specific terms of those CPDs, on metrics for its future performance, for example its manufacturing capacity utilization, product cost, or delivery service level and lead time.

Because an entity's rights and obligations under its CPDs depend on the outcome of uncertain future events, and its performance will in general also be impacted by other sources of uncertainty, in many cases an entity may wish to evaluate performance metrics that are contingent on the outcome of potential future events, hereafter referred to as “Contingent Performance Metrics”, or “CPMs”.

For instance, under the terms of its CPDs with sales teams, the manufacturing team in the example above may face uncertainty about the number or type of products it will be called on to deliver in future periods. As a result, it may wish to quantify how alternative prospective CPDs for raw materials will impact its raw material inventory and product supply performance over this range of potential future product delivery requirements.

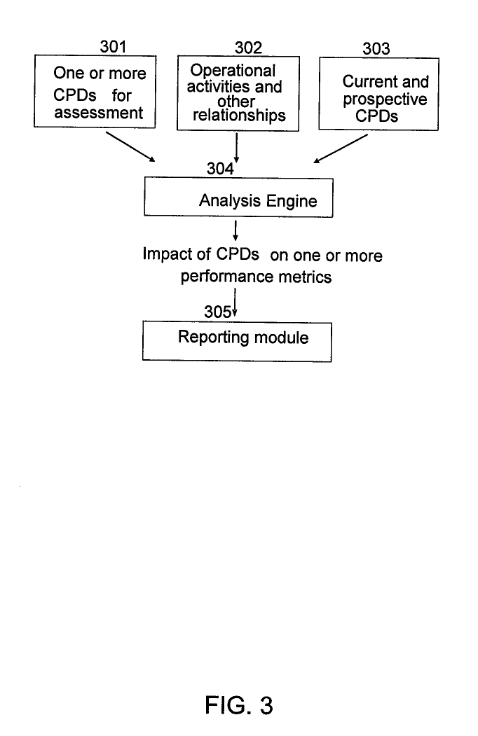

FIG. 3 shows the relevant process steps. In step 301 the one or more current or prospective CPDs to be assessed are entered. In step 302, the operational activities of the organizational entity, including counterparty relationships of the organizational entity where CPDs are not in place, are entered. In step 303 other current and prospective CPDs of the organizational entity are entered. In step 304 an analysis engine evaluates the impact of the terms of the one or more current or prospective CPDs from step 301 on one or more performance metrics for the organizational entity. In step 305 a reporting module presents results of the analysis engine of step 304. Each of these steps directly parallels the steps 101-105 above. However, the process differs in step 304, where the analysis engine described in step 104 is configured to provide the impact on the relevant performance metrics, and also differs in step 305, where that impact is reported.

In step 305, similar to step 105, it will in general be desirable for the system to generate reports tailored to the characteristics of the one or more CPDs being assessed, for example the CPDs for raw materials versus the CPDs for completed products in the example above. Doing so allows the reports to focus on the performance metrics most relevant to the analysis and design of the specific CPD or CPDs in question. Also similar to step 105 above, different members of the organizational entity will in general benefit from reports that summarize the impact of the CPDs in question on the performance metrics most relevant to their individual areas of responsibility, since this information will enable them to provide more detailed and specific input on the design and selection of the CPDs to create the greatest value. Finally, to enable the impact of the rights and obligations of the CPDs under specific elements or subsets of relevant SPFEs to be assessed, and these rights and obligations selected to best meet business objectives, reports that communicate the impact of the CPDs on performance metrics over elements of relevant SPFEs or outcomes of other sources of uncertainty may be generated.

For example, FIG. 2 above shows values for variables which may serve as performance metrics for a procurement organization, such price per unit, total sourcing cost, and inventory cost. Values for each metric are shown for different potential values of the organizational entity's uncertain future demand for the good, which is typically a key source of uncertainty for a procurement organization. Similar reports may be generated to show how the values of performance metrics vary across the uncertain future price or availability for the good, or other relevant sources of uncertainty, or events from the SPFEs of relevant CPDs.

C. Systems and Methods of the Kind Described in Sections A or B Above Made Available to Other Organizational Entities or External Parties

An organizational entity may choose to make systems or methods of the kind described in Section A or B above, which have been developed to assess the impact of CPDs on the organizational entity's activities and performance, available to other organizational entities within the same firm, and in some cases to external parties. The rationale for doing so is to help these other organizational entities or external parties understand how the terms of current or prospective CPDs which they may seek to establish with the modeled organizational entity will impact the modeled entity's operational activities, its portfolio of other CPDs, and/or its performance. Making this information available to the other entities enables the entities to more efficiently identify CPDs that meet both their needs and objectives, and those of the modeled entity.

For example, without access to a system or method to quantify the impact of a prospective CPD on the operational activities, other CPDs, or performance of a counterparty organizational entity, the sales and procurement teams in the example above may need to propose and counter-propose terms for many different prospective CPDs before identifying a CPD that meets the counterparty organizational entity's objectives and requirements. In contrast, if they have access to such a system or method for the organizational entity the efficiency and effectiveness of their efforts to identify mutually beneficial CPDs will be greatly enhanced.

The benefit of making such a capability available to other organizational entities or external parties can be even larger if two or much such entities are able to utilize the capability to jointly optimize their CPDs with the entity. For instance, if a procurement organization, a sales organization, and an external supplier that each interact with a manufacturing organization each have access to a system and method for assessing the impact of prospective CPDs on the manufacturing organization's operational activities, CPDs, and/or performance metrics, they can jointly optimize their CPDs with the manufacturing organization to create the greatest overall value.

More generally, by making such systems and methods developed for several, or even all, organizational entities within a firm available to other organizational entities within the firm and potentially to external parties, substantial improvements in both the efficiency and effectiveness with which beneficial CPDs can be established within a firm and with relevant external partners can be achieved.

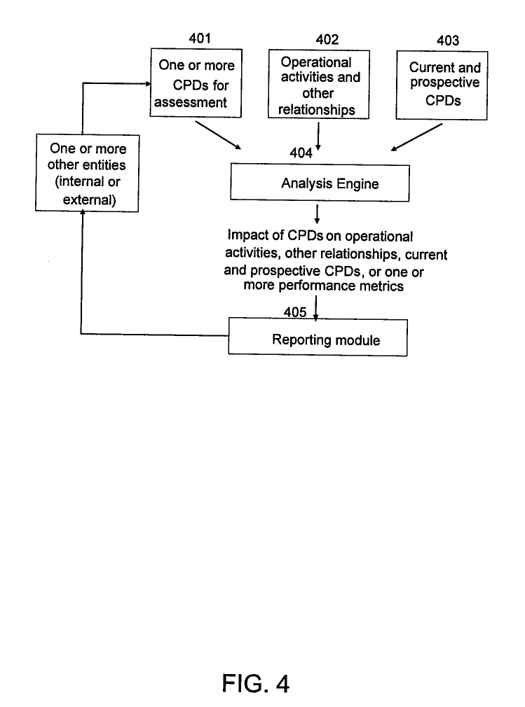

FIG. 4 shows the relevant process steps. In step 401 the one or more current or prospective CPDs to be assessed are entered by the one or more other organizational entities or external parties. In step 402, the operational activities of the organizational entity, including counterparty relationships of the organizational entity where CPDs are not in place, are entered. In step 403 other current and prospective CPDs of the organizational entity are entered. In step 404 an analysis engine evaluates the impact of the terms of the one or more current or prospective CPDs from step 401 on one or more performance metrics of the organizational entity, or on its operational activities, including its counterparty relationship where CPDs are not in place (from step 402), or on its other current or prospective CPDs (from step 403). In step 405 a reporting module presents results of the analysis engine of step 404. As the figure shows, the reports generated are made available to the one or more organizational entities or external parties that entered current or prospective CPDs in step 401.

Following the discussion above, in step 401 the system may be configured to allow individual organizational entities or external parties to enter CPDs to be assessed, or to allow two or more such internal or external entities to jointly enter two or more CPDs to be assessed. Steps 402 and 403 follow steps 102 and 103 above. Step 404 follows either step 104, if the impact of the one or more CPDs to be assessed is on the operational activities of the organizational entity, including its counterparty relationships where CPDs are not in place, or its other current or prospective CPDs, or step 304, if the impact to be assessed is on one or more performance metrics for the organizational entity.

Step 405 follows the basic considerations of either steps 105 or 305 above, depending on whether the impact of the CPDs to be assessed is on the operational activities of the organizational entity, including counterparty relationships where CPDS are not in place and /or the other current or prospective CPDs of the organizational entity (step 105), or on one or more performance metrics for the organizational entity (step 305). In either case, however, additional considerations arise because the reports are being generated for one or more separate parties. First, the content of the reports may be selected to match the areas most relevant to the one or more parties, and to the design and analysis of the types of CPDs the parties wish to assess. Second, the organizational entity may wish to limit the nature and extent of information made available to the one or more parties, particularly if one or more of the parties is an external party rather than another organizational entity within the same organization. Third, depending on the nature of the relationship between the parties, access management features which were not required when the system was used only by members within the organizational entity, such as security and permissions, may also be important.

As an example, some or all of the information show in Chart 1 above may be made available to the counterparties of the CPDs whose impact is shown in the chart. In one instance an internal counterparty may be shown most or all of the information in the chart, while an external counterparty may only be shown a subset. For example, an external counterparty may be shown the graphics, which communicate the ability of a CPD, or portfolio of CPDs, to meet demand across the procurement organization's range of potential future demand, but not shown the tables, which include data about the impact of the one or more CPDs on specific operational variables and performance metrics. Alternatively, a specific counterparty may be shown values for one or more variables from the tables, such as individual variables that pertain specifically to its activities, or summary variables, such as the Total Sourcing Cost variable, but not the values of each of the variables which make up Total Sourcing Cost.

D. Systems and Methods to Evaluate the Impact of One or More Current or Prospective CPDs on the Operational Activities, Current or Prospective CPD Portfolios, and/or Performance Metrics of Two or More Organizational Entities

To further assist managers of individual organizational entities and external parties identify CPDs that provide the greatest benefit, systems and methods may be developed to jointly assess the impact of one or more current or prospective CPDs on the operational activities, CPD portfolios, and/or performance metrics of two or more organizational entities, rather than a single organizational entity. Like the systems and methods described in section C above, the purpose of such systems and methods is to enable entities to more efficiently and effectively identify CPDs which provide the greatest overall value, in this case across two or more organizational entities.

For example, an entity responsible for managing capacity, materials, or other resources utilized by multiple organizational entities may wish to know how a CPD which it may establish with one such entity will impact the operational activities, current or prospective CPD portfolios, or performance metrics of one or more of the other organizational entities which utilize the same resource.

As a second example, a general manager of a business unit may wish to know how current or prospective CPDs of organizational entities within his or her organization, such as manufacturing, procurement, or sales, will impact the operational activities, CPD portfolios, and/or performance metrics of other organizational entities within the business unit.

As a third example, an organizational entity responsible for sourcing one of several materials required to build a product may wish to know how a prospective CPD it may establish for the material will impact the performance metrics, operational activities, and/or CPDs of one or more organizational entities responsible for sourcing other required materials, and/or those of the entity responsible for securing all the materials required to build the product. For example, two prospective CPDs may both meet the needs of the entity responsible for the entire bill of materials. However, the first CPD may impose greater costs or risks on the organizational entities responsible for sourcing the other required materials than the second CPD.

For the reasons described in Section C above, access to systems and methods of the kind described here may be given to organizational entities other than the modeled organizational entities, and in some cases to external parties, in order to enable such parties to more efficiently and effectively identify CPDs that create the greatest overall value. For example, the business unit general manager in the second example above may make a system and method for assessing the impact of prospective CPDs on two or more organizational entities within the business unit available to other organizational entities within the business unit, and ask these organizational entities to structure CPDs to meet objectives specified by the general manager.

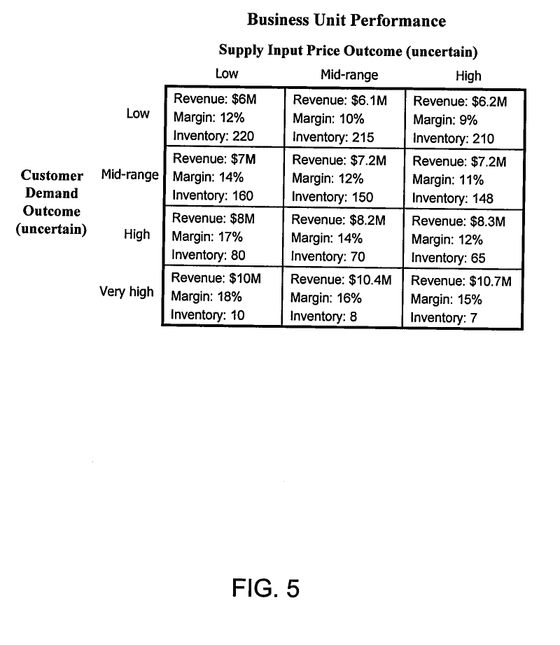

FIG. 5, for example, is a representation of a system report that the manager may make available to the sales and the procurement teams within the business unit. The FIG. 5 report shows the overall performance of the business unit as a function of the CPDs which the sales team has put in place with customers of the business unit, and the CPDs which the procurement team has put in place with suppliers of the business unit. Members of the sales and procurement organizations can use the system to assess the impact of prospective CPDs on key performance metrics for the overall business unit, and to generate CPDs which create the greatest benefit, according to criteria for the values of the variables shown in the chart specified by the general manager. In the specific report shown in FIG. 5, the business unit's revenue, gross margin, and inventory level are shown across potential values of its uncertain future demand and the uncertain future price of key supply inputs.

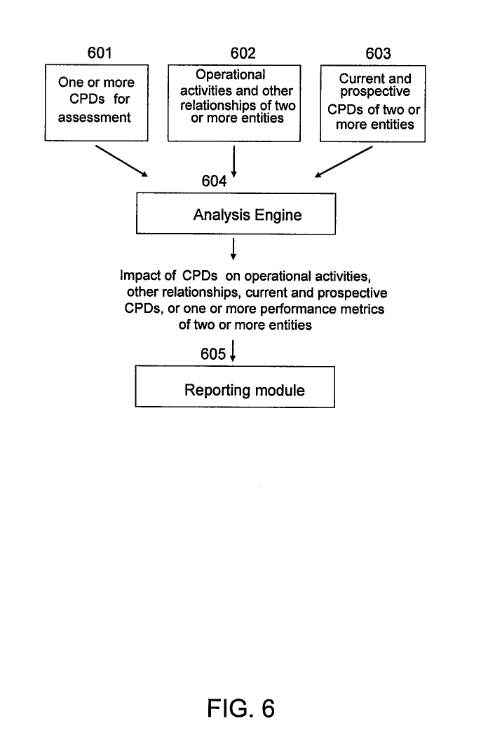

FIG. 6 shows the relevant process steps. In step 601 the one or more current or prospective CPDs to be assessed are entered. The system may be configured to allow relevant organizational entities or external parties to individually enter CPDs to be assessed, or configured to allow two or more such internal or external entities to jointly enter two or more CPDs in order to assess their combined impact. In step 602 the operational activities of the two or more organizational entities, including counterparty relationships of the organizational entities where CPDs are not in place, are entered. In step 603 other current and prospective CPDs of the two or more organizational entities are entered. Thus steps 602 and 603 parallel steps 102 and 103 above, but cover two or more organizational entities rather than only one. To enable this information to be entered for each organizational entity, the system may be configured to allow each such entity to enter its own information in steps 602 and 603. In step 604 an analysis engine evaluates the impact of the terms of the one or more current or prospective CPDs from step 601 on one or more performance metrics for the two or more organizational entities, or on their operational activities, including counterparty relationship where CPDs are not in place (from step 602), or on their other current or prospective CPDs (from step 603). Step 604 parallels step 404 above, except that the analysis is conducted for the two or more organizational entities in question.

In step 605 a reporting module presents results generated by the analysis engine of step 604. Because multiple parties are involved, reporting capabilities similar to but somewhat more extensive than those of step 405 above will in general be required. Specifically, as in step 405 each organizational entity whose activities are evaluated may wish to limit the information reported about the impact of the CPDs being assessed on its operational activities, its other CPDs, or its performance metrics. To accomplish this, the system may provide each such organizational entity with the ability to manage the subset of reporting content about its activities that is made available to specific users of the system, based on the organizational affiliation or role of the user. For example, users from the same organizational entity may be granted access to all information about the impact on the organizational entity, users from other organizational entities within the firm access to most information, and users from external parties only carefully selected subsets of the information.

It should be noted that systems and methods that span two or more organizational entities will in general have strengths and weaknesses relative to the systems and methods of sections A-C above. Their strengths include their ability to allow individual organizational entities to assess the broader organizational impact of current or prospective CPDs, and by doing so enable them to design CPDs to provide the greater overall benefit. Their primary weakness is that they may be complex to construct and utilize. As a result, in some cases it may be more efficient for individual organizational entities to focus on the more immediate scope of impact of their CPDs, and to rely on the counterparties of those CPDs to appropriately quantify and manage the broader impact of the CPDs.

It may also be possible to at least approximately assess the broader impact of CPDs with well constructed systems and methods for individual organizational entities. For example, in the third example above the entity responsible for the entire bill of materials for a product may be able to assess the impact of CPDs for each individual material sufficiently well to eliminate the need for a system and method to jointly assess the operational activities, CPD portfolios, or performance metrics of the organizational entities responsible for sourcing the individual materials. Similarly, in the second example the general manager may choose to establish a portfolio of CPDs with the organizational entities within his or her business unit, and to use these CPDs to coordinate and manage relevant interdependencies across the operational activities managed by the organizational entities.

E. System and Method to Evaluate the Impact of the Terms of One or More Current or Prospective CPDs on the Operational Activities, Including Current or Prospective CPDs, of Two or More Organizational Entities Relevant to a Specific Operational Activity, or on Performance Metrics for that Activity

The systems and methods of section D above enable CPDs to be structured to provide the greatest possible benefit to the operational activities, CPDs, and/or performance of two or more organizational entities. In many firms, however, there are important activities which are accomplished jointly by two or more organizational entities, but for which participation by one or more of these entities represents only a portion of that entity's overall activities. For important activities of this kind it is often useful to establish systems and methods that have been designed specifically to enable CPDs to be structured to provide the greatest possible benefit to such activities. This can be done by quantifying how current or prospective CPDs impact the activities, or other CPDs related to the activities. These systems and methods differ from those described above because they focus on the impact of CPDs on specific operational activities, rather than the operational activities of one or more organizational entities.

For example, in many firms “sales and operations planning” refers to an activity in which representatives from several organizational entities, such as supply planning, demand planning, sales and marketing, and general management assess strategies for the joint management of production and sales. Often no one organizational entity is responsible for the sales and operations planning process, and the organizational entities that participate in the process are typically responsible for other activities that have only limited relevance to the sales and operations planning activity. Under such circumstances it may be useful to develop a system or method that enables participants in the sales and operations planning process to assess how current or prospective CPDs impact sales and operations planning activities, including relevant performance metrics, operational activities, and other current or prospective CPDs.

As a second example, in many organizations there are entities responsible for specific products or product lines, whose activities focus only on those products or products lines, as well as organizational entities responsible for specific functional capabilities, such as procurement, manufacturing, logistics, or IT, which provide those capabilities to multiple product or product line management organizations. In organizations where this is the case it is often useful to construct systems or methods able to incorporate all of the operational activities and CPDs of entities responsible for a product or product line, but only the subsets of the operational activities and CPDs of the supporting functional organizations (e.g. procurement, manufacturing, logistics, IT . . . ) relevant to that product or product line.

Whether it will be most effective to use a system or method focused on a specific activity, as described here, or a system or method for one or more organizational entities as described above, will in general depend on the organizational structure of a firm and on the nature of the operational activities which must be coordinated and managed across the organizational entities defined by that organizational structure.

As described in sections C and D above, a firm may choose to make systems or methods of the kind described here available to other organizational entities within the firm, and in some cases to external parties, in order to allow those entities to more efficiently identify CPDs that meet both their needs and objectives and those of the specific activities.

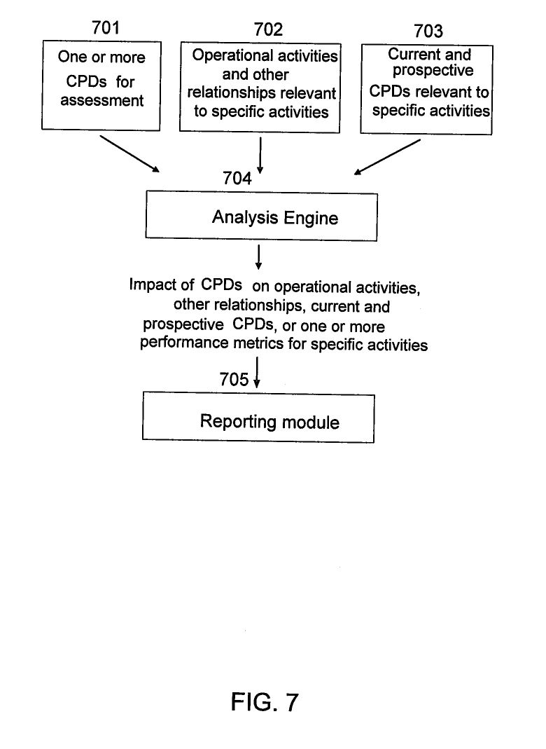

FIG. 7 shows the relevant process steps. In step 701 the one or more current or prospective CPDs to be assessed are entered. The system may be configured to allow individual organizational entities or external parties to enter CPDs to be assessed, or to allow two or more such internal or external entities to collaborate to enter two or more CPDs so that their combined impact may be assessed. In step 702, the operational activities relevant to the specific activity, including counterparty relationships where CPDs are not in place, are entered. In step 703 other current and prospective CPDs relevant to the specific activity are entered. Thus steps 702 and 703 parallel steps 102 and 103 above, but address the specific activity in question, rather than the activities of specific organizational entities. Because multiple organizational entities participate in the specific activity, in steps 702 and 703 the system may be configured to allow each such entity to enter information relevant to its role in the activity, similar to step 602 and 603.

In step 704 an analysis engine evaluates the impact of the terms of the one or more current or prospective CPDs from step 701 on one or more performance metrics for the specific activities, or on relevant operational activities, including counterparty relationships where CPDs are not in place (from step 702) and other relevant current or prospective CPDs (from step 703). Thus step 704 parallels step 404 above, except that the analysis is conducted for the specific operational activities in question, rather than for the operational activities of an organizational entity.

In step 705 a reporting module presents the results of the analysis engine of step 704. Because multiple parties are involved, reporting capabilities similar to those of step 605 above will in general be required. Specifically, each organizational entity responsible for activities included in the set of activities analyzed may wish to limit the information reported about the impact of the CPDs on its activities. To accomplish this, the system may provide each such organizational entity with the ability to manage the subset of available reporting content that pertains to its activities which is made available to specific users of the system, based on the organizational affiliation and role of the user. For example, users from the same organizational entity may be granted access to all information about the impact on the organizational entity, users from other organizational entities within the firm that also participate in the specific activity access to most information, and users from other organizational entities within the firm and external parties only selected subsets of the information. Subject to these potential limitations, reports may be generated to serve each of the purposes and to present each of the categories of information listed under the description of steps 105 and 305 above. Note that because the specific activities assessed involve activities managed by multiple organizational entities, reports that convey at least the high level impact of prospective CPDs across the scope of the specific activities will be important to ensure that the CPDs that create the greatest overall value are identified.

F. System and Method to Enable Coordinated Structuring of Interdependent CPDs Based on Their Net Impact on Operational Activities, Other CPDs, and/or on Performance Metrics

As described above, important interdependencies frequently exist between CPDs for related activities. When such interdependencies are straightforward and well understood, and relevant counterparties have close and cooperative working relationships, it may be possible to structure the interdependent CPDs to produce the greatest overall benefit by utilizing systems such as those described in subsections C, D and E above, which quantify and report the impact of CPDs on operational activities across multiple organizational entities, in combination with organizational processes that facilitate the joint structuring of interdependent CPDs.

In many cases, however, the level of collaboration between counterparties required to effectively structure interdependent CPDs in such a manner may be either infeasible or inefficient. In such cases, an organization may benefit from a system and method that enables the interdependent CPDs to be structured in a partially or fully decentralized manner. Such a decentralized system and method must ensure, however, that the interdependent CPDs have a combined impact that provides the greatest overall value. Such a system and method is described below. Under the system and method the contribution of individual CPDs is measured based on the change in impact of the overall set of interdependent CPDs that is enabled by the individual CPD.

Before describing the system, a business example is useful to clarify the problem addressed and approach taken. Assume that a sales team has identified a customer willing to purchase a large quantity of one of a company's products. However, an initial review of the resources of the manufacturing team that would be tasked with building the products has revealed that capacity or material constraints exist which would require the manufacturing team to incur prohibitively high costs to deliver the products. It is believed, however, that if these initially assessed constraints and costs are made known to other organizational entities, one or more such entities may be able to reduce mitigate them. For example, a procurement team may be able to secure additional raw material from an alternate supplier, or a second manufacturing team may determine that it is also capable of building the product. Under the system and method disclosed here, these teams would be rewarded for identifying and executing such opportunities based on the impact of their actions on the cost or feasibility of meeting the sales opportunity. Specifically, the impact of their actions would be measured by the changes in impact on relevant operational activities, other CPDs, or performance metrics, as quantified by systems and methods of the kind described in subsections C, D and E above, that result from the actions. Once such adapting or accommodating changes have been made, the sales team's contribution would be assessed based on similar measures of the net impact of the sales opportunity on key impact areas.

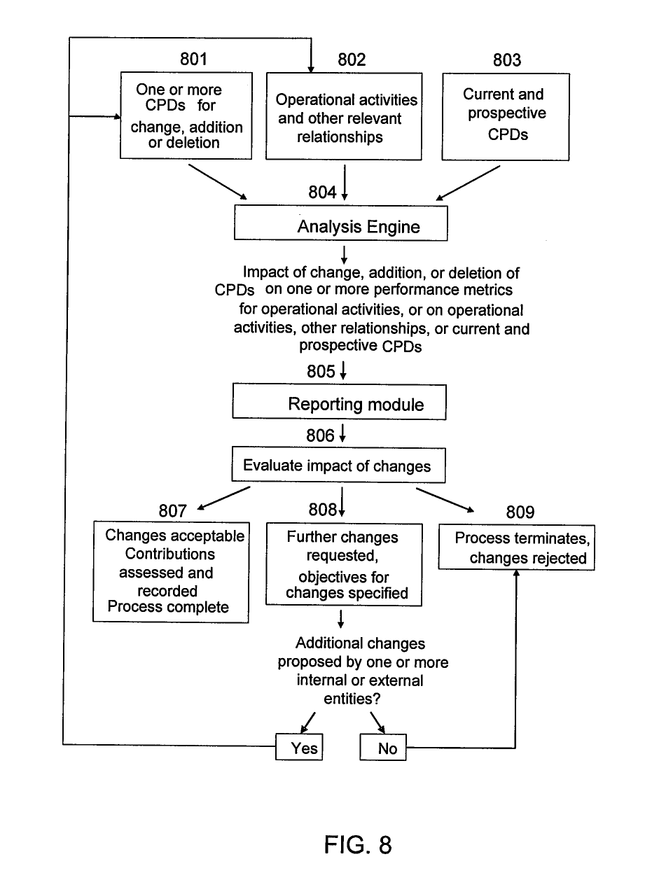

FIG. 8 shows the relevant process steps. In step 801 one or more CPDs related to the interdependent activities are entered. As in steps 401 and 501 above, the system may be configured to allow individual organizational entities or external parties to enter CPDs to be assessed, or to allow two or more such internal or external entities to collaborate to enter two or more CPDs so that their combined impact may be assessed.

In step 802 the operational activities related to the interdependent activities are entered, including counterparty relationships where CPDs are not in place. In step 803 other current and prospective CPDs related to the interdependent activities are entered. Since the system may utilize any of the systems described in subsections C, D or E above, in steps 802 and 803 the system may be configured to allow a single organizational entity to enter the relevant information (if the impact of the interdependent activities on a single organizational entity is to be assessed), or configured to allow multiple entities to each enter information relevant to their activities (if the impact of the interdependent activities on two or more organizational entities, or on specific operational activities that involve two or more organizational entities, is to be assessed).

In step 804 an analysis engine evaluates the impact of the one or more CPDs from step 801 on one or more performance metrics for the operational activities, or on the operational activities themselves, including relevant counterparty relationship where CPDs are not in place (from step 802) and other relevant current or prospective CPDs (from step 803). The relevant analysis engine is the analysis engine from steps 304, 404, or 504 above, depending on the nature and scope of the impact being assessed, e.g. impact on one organizational entity, two or more organizational entities, or specific operational activities involving multiple organizational entities.

In step 805 a reporting module presents results of the analysis engine of step 804. Like step 804, the specific reports generated and the users to which specific reporting content is made available in this step 805 will vary with the scope of the impact being assessed and the role of the organizational entities involved, mirroring steps 305, 405, or 505 from the systems described above, and consistent with system configuration in steps 801-804. Reporting conventions will also depend on whether the system is implemented in a more centralized or decentralized manner, as described below.

For example, if the operational activities of a single organizational entity are being assessed, a report such as the one shown in FIG. 2 above may be generated. Alternatively, if the operational activities of multiple organizational entities within a business unit are being assessed, a report such as the one shown in FIG. 5 above may be generated. Depending on the organizational affiliation of a specific user, all or only a portion of the content of such reports may be made available to the user.

In step 806 the impact of the one or more CPDs being assessed (hereafter “the change”) is evaluated. If the impact of the change is acceptable “as is” based on the results presented, and no additional related changes associated with the interdependent activities are required or desired prior to accepting the change, in step 807 the process is complete and the change is accepted. The counterparties of each of the CPDs that comprise the change are notified, and the contribution of each CPD to the overall impact of the change is assessed and recorded.

If additional changes are either desired or required to modify or improve the impact of the currently proposed change, in step 808 the results of the evaluation of the impact of the change, and desired areas for modification or improvement in the impact, are made available to one or more organizational entities or external partners believed to have the potential to provide such modification or improvement. For example, one or more of the data fields in FIG. 2 or FIG. 5 above, as the case may be, may be identified for change, and the desired changes communicated to relevant organizational entities or external partners. If an additional prospective change is proposed by one or more of these parties in response, the process returns to step 801, if the additional changes involves CPDs, and/or to step 802, if the additional change involves operational activities or other relevant counterparty relationships.

If the evaluation in step 806 reveals that the impact of the proposed change is unacceptable and further search for additional refinement or improvement of the change is not desired, the process is terminated in step 809 and the potential changes are rejected.

As a configuration option for the system and method, steps 806-809 may be executed as part of a more decentralized, automated process or as part of a more centralized, controlled process, or according to a range of alternative processes between these extremes.

For example, in a decentralized, automated implementation, prior to step 801 relevant organizational entities and external parties are first identified based on the scope of the operational activities subject to interdependencies, and objectives for the impact of the change are communicated to the identified entities. In addition, criteria may be communicated to the identified entities to specify the nature and extent of the impact of a change which will (1) trigger acceptance of the change, (2) trigger a request for further refinement and improvement of the change, and (3) trigger rejection of the change. If established, such criteria may also be included in evaluation steps 806-809. Finally, the identified entities are provided access to the system as described in steps 801-809 above, and use it to evaluate prospective changes which they may develop, either individually or collaboratively, to meet the specified objectives and criteria for acceptance of proposed changes.

In contrast, in a more centrally managed implementation, prior to step 801 a managing entity issues requests for prospective changes to one or more organizational entities and/or external parties involved in the interdependent activities. If and when such an entity offers a proposed change, the managing entity uses the system described above to assess the impact of the proposed change. Based on the impact determined, the managing entity either notifies the relevant entity that its proposed change has been accepted or rejected, or requests a further refinement or modification of the proposed change. Thus in contrast to the decentralized implementation, only the managing entity is aware of the participating organizational entities, the changes they propose, the impact of those changes, and the interdependencies with other proposed changes, and only the managing entity directly utilizes the system as described in steps 801-809 above.

The decentralized approach has the benefit of enabling relevant organizational entities and external parties to continuously monitor and either independently or collaboratively evaluate opportunities for improvement over time, but requires more information to be shared about objectives for change, participating entities, and proposed changes and their impact. In contrast, under the centralized approach very little such information must be shared, but one or more managing entities must identify opportunity areas for change, and evaluate changes which are proposed. As noted above, these specific examples should be considered extremes of a range of potential implementation processes, with many other potential processes that are either less centralized or less decentralized also consistent with the system and methods described above.

III. Systems and Methods for Automation of Techniques Described Above

The systems and methods described above enable organizational entities to efficiently structure high performance CPDs by giving them the ability to analyze the impact of prospective CPDs on the operational activities, other counterparty relationships, and performance metrics of relevant organizational entities.

Organizations can gain further benefit from the use of CPDs, and from the systems and methods described above, with supporting systems that partially or completely automate one or more related tasks. Systems of this kind are described below. The systems provide the capability to: 1) identify operational activities and/or counterparty relationships which may benefit from the use of CPDs, 2) recommend some or all terms of CPDs, including SPFEs and/or rights and obligations, and 3) monitor evolving circumstances and conditions related to CPDs and recommend appropriate actions, including utilization of existing CPDs, and addition, modification, and removal of CPDs. The systems are described in more detail below.

A. Systems to Identify Operational Activities and/or Counterparty Relationships which May Benefit from the Use of CPDs

In order to utilize CPDs most effectively, an organizational entity must determine which operational activities and counterparty relationships may benefit from their use.

As described above, CPDs are most useful for improving coordination of operational activities between parties when the operational activities are subject to uncertainty. This is true because by specifying rights and obligations over a set of potential future events, CPDs enable their counterparties to proactively identify relevant sources of uncertainty and potential future events associated with those sources of uncertainty, and to coordinate their planning and management of operational activities related to those potential events.

Accordingly, a user may benefit from a system which identifies operational activities subject to significant uncertainty, including both activities of the user's own organizational entity, and activities of the user's counterparty organizational entities. After identifying operational activities subject to significant uncertainty, the system may apply additional screens to further refine the identification of activities and counterparty relationships suitable for CPDs, such as whether the activities are material from a business perspective, and whether the use of CPDs with the one or more activities or counterparties identified is desired by the user.

For example, a member of a procurement organization may benefit from a system that monitors the level of uncertainty about key sourcing variables for the products and services which the organization purchases, including variables associated with particular counterparties, and which alerts the user of all products, services, and counterparties exposed to levels of uncertainty for one or more such variables which exceed a specified criteria.

Relevant sourcing variables may include purchase price, purchase quantity, supply availability, lead time, and on time delivery, and supplier performance variables such as quality, delivery reliability, and financial health.

After an initial screen based on the level of uncertainty of such variables, the system may further screen for business significance of the identified products or services, such as the financial value of the procurement organization's purchases of the product or service, including, where relevant, purchases from specific counterparties. Other potential measures of business significance include the impact of disruptions in the supply price, availability, or quality of the product or service on the firm's manufacturing or distribution activities, or on its sales revenue or margin.

Before presentation of such recommendations to the user, the system may also compare them against stored user preferences delineating products, services, or counterparties for which the use of CPDs is either desired or not desired by the user.

As a second example, a user in a sales organization may benefit from a system that monitors the level of uncertainty about key sales variables, such as price, quantity, inventory, delivery lead time, product specifications, or “mix” of products or services sold. Such variables may be monitored at either at the level of overall sales, or at the disaggregate level of sales to particular customers, sales in particular regions, or sales by one or more specified sales teams or partners.

After an initial screen based on the level of uncertainty of relevant sales variables, further screens may be applied before presenting results to the user. These may include screens based on 1) the magnitude of the impact of the uncertainty about the variables identified on relevant operational activities and performance metrics, and 2) user preferences for the use of CPDs for specific products, services, and counterparties.

It should be noted that that the system as described need not apply only to assessment of operational activities and counterparty relationships which are not currently managed with CPDs, but may also apply to activities and relationships which are currently managed with CPDs. For example, it may be the case that the level of uncertainty and/or business impact of particular activities has been high in the past, meriting the use of CPDs in related counterparty relationships. However, if the level of uncertainty and/or business impact of the activities has since dropped, it may no longer be desirable to utilize CPDs in counterparty relationships related to the activities. Similarly, a particular counterparty may have been an important business partner in the past, meriting the use of one or more CPDs to better coordinate operational activities with it, but due to a change in circumstances it may no longer be an important business partner, and CPDs no longer required.

To summarize, the system may provide recommendations that identify opportunities to create value by initiating the use of CPDs for particular operational activities and/or with particular counterparties, and by terminating the use of CPDs for particular operational activities and/or with particular counterparties.

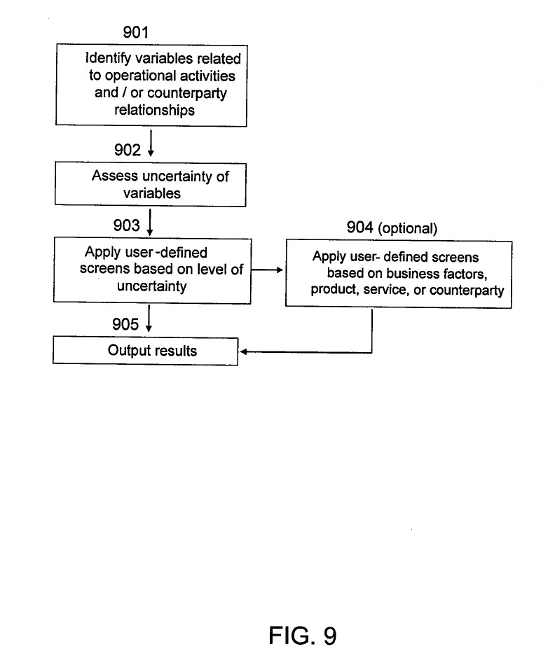

The system operation is illustrated in FIG. 9. In the first operation 901 variables related to the operational activities and/or counterparty relationships to be analyzed for suitability of CPDs are identified. Examples include the variables related to procurement activities and counterparty relationships, and to sales activities and counterparty relationships, described above. In step 902 the uncertainty of the variables is assessed. Any of a wide range of statistical measures, for example variability, variance of cumulative or average values over time, range of values (e.g. minimum, maximum), forecast error, etc. may be utilized.

In step 903 user-defined screens based on level of uncertainty are applied. Both variables related to operational activities and/or counterparty relationships for which CPDs are not currently in use, and which have levels of uncertainty above user-defined levels, and variables related to operational activities and/or counterparty relationships for which CPDs are currently in use, and which have levels of uncertainty below user-defined levels, are identified. In step 904 optional additional user-defined screens are applied to the variables identified in step 903. Such screens may be based on, among other things, business impact or product, service, or counterparty addressed, or categories thereof. As in step 904, both variables related to operational activities and/or counterparty relationships for which CPDs are not currently in use, and which pass any such screens, and variables related to operational activities and/or counterparty relationships for which CPDs are currently in use, and which fail to pass any such screens, are identified.

In step 905 the system outputs the results of steps 903, or if applicable optional step 904, to the user. Operational activities and/or counterparty relationships for which CPDs are not currently in use, and which have passed the user-specified screens, are identified as candidates for CPDs. Operational activities and/or counterparty relationships for which CPDs are currently in use, and which have failed one or more such screens, are identified are activities or relationships for which CPDs may no longer required.

B. Systems to Recommend Some or all Terms of a CPD

An organization's ability to efficiently and effectively generate high performance CPDs may also be augmented by a system which generates recommendations for some or all of the terms of a CPD by conducting analysis of information relevant to the determination of such terms. Systems to recommend SPFEs and/or rights and obligations of CPDs are described below.

Recommendation of SPFEs

To generate recommendations for some or all elements of the SPFE of a CPD, a system may analyze the nature and extent of uncertainty about variables relevant to the operational activities to which the CPD applies. After variables which meet requirements for level of uncertainty have been identified, additional screens may be applied, including screens based on business impact of the variables and other user-specified criteria.

After a set of relevant variables has been identified, the system may generate a SPFE for the CPD based on the variables. Under one approach, the system may generate probability distributions for the variables, and then specify the potential future events of the SPFE so that they cover some or all of the range of potential future events spanned by the probability distributions of the variables.

As an example of the use of such statistical and probabilistic analysis to generate a SPFE, such methods may be used to generate a SPFE for the CPD shown in Table 1 above. To do so, first the range of potential future values of the input supply price and of customer demand is estimated. Next the system divides the range for each of the variables into intervals, and constructs a grid of the kind shown in the Table 1 to serve as the SPFE for the CPD. Based on user-specified input or criteria, this initial SPFE may subsequently be refined by the system. For example, the user may specify larger or smaller grid intervals, or expansion or contraction of the minimum or maximum values of one or both of the ranges.

It will be apparent to those skilled in the art that for SPFEs which depend on three or more sources of uncertainty, the grid-based approach described here can be extended in an obvious way to generate a multi-dimensional discrete representation of the relevant probability space.

To generate the necessary probability distributions the system may analyze historical data about the variables, projections of their future values, and other data relevant to the estimation of the probability distribution of the variables extracted from enterprise systems and/or external data sources.

To improve the statistical validity of the estimates, particularly for variables for which little or no directly relevant data is available, the system may also identify other related variables, and utilize analysis of the uncertainty of these variables to improve the estimates of the uncertainty of the variables of interest. For example, to better estimate uncertainty about the future price of or demand for a particular product or service, the system may also analyze uncertainty about the price of or demand for other products and services believed to share similar characteristics. To enable such comparisons, data normalization and other relevant statistical techniques common in the art may be utilized.

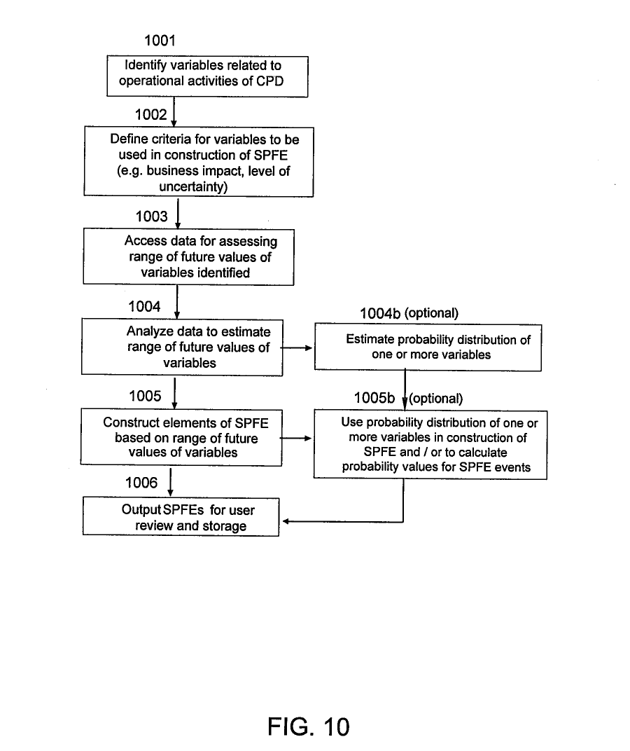

The system operation is illustrated in FIG. 10. In step 1001 variables related to the operational activities of the CPD are identified. In step 1002 criteria are defined for identification of the variables to be used to construct the SPFE. As described above, criteria may based on the nature and extent of uncertainty about the future values of the variables, the business impact of the variables, or other relevant criteria. In step 1003 data relevant to the assessment of the range of potential future values of the variables is accessed. As described above, such data may include historical data about the variables, projections of their future values, and data about other related variables believed to share similar characteristics. In step 1004 the data is analyzed and used to estimate the range of potential future values of the variables. In optional step 1004b, the relative likelihood, or probability distribution of, one or more such variables is estimated. In step 1005 some or all elements of the SPFE are constructed based on information about the range of future values of the variables, for example using the grid-based discrete representation approach described above. In optional step 1005b, information about the probability distribution of one or more of the variables from step 1004b is used to refine the SPFE from step 1005, and may also be used to determine probabilities values for one or more elements of the SPFE. In step 1006 the relevant SPFE values are output for user review and storage in the relevant data location.

Recommendation of Rights and Obligations

The system may also generate recommended values for one or more of the rights and obligations of a CPD. Rights and obligations may be generated based on the SPFE of the CPD, probability distributions of relevant variables, and/or user-specified performance objectives for or constraints on relevant operational activities. Methods for generating recommendations based on each of these forms of data or a combination thereof are described in more detail below.

It is often valuable for a system to generate candidate rights and obligations for a CPD based on analysis of the characteristics of the SPFE of the CPD, and/or of probability distributions for variables related to the SPFE, since the rights and obligations of a CPD are specified over the SPFE of the CPD.

For example, a procurement organization may specify policies to guide system-based generation of CPD rights and obligations based on probability distributions for the procurement organization's future demand for a product or service, and/or for the product or service's future price, which have been used in the specification of the SPFE of the CPD.

As an example, the system may generate an obligation to purchase a quantity of the product or service equal to the 10th percentile of the probability distribution of future demand, and request a right to purchase additional quantity of the product or service up to the 90th percentile of future demand. It may also generate a price obligation equal to a specified percentile of the probability distribution of the future price, for example the expected price minus 5%, or another similar function of the probability distribution of the future price, such as a price defined relative to an uncertain future pricing benchmark or index.

A wide range of other variables related to the operational activities addressed by the CPD may be utilized in a similar way, including variables related to counterparty activities. For example, in the procurement example above rights and obligations may also be defined based on probability distributions for variables related to a supplier's quality, lead time, available capacity, or total available supply.

A second method for system-based generation of recommendations for the rights and obligations of a CPD is based on user-specified policies for the impact of the rights and obligations, including impact on operational activities or performance metrics related to the CPD.

For example, a user may specify requirements for impact on operational activities related to the CPD which the CPD rights and obligations must satisfy, such as minimum, maximum, percentile or average values for particular variables or performance metrics. To determine rights and obligations which meet these requirements the system may utilize the systems and methods described in subsections A-E of Section II above for quantifying the impact of CPDs, together with search algorithms or related optimization methods. After suitable rights and obligations have been identified the system may present them to the user for review, together with one or more reports showing the impact of the rights and obligations on the relevant operational activities, performance metrics, or counterparty relationships.

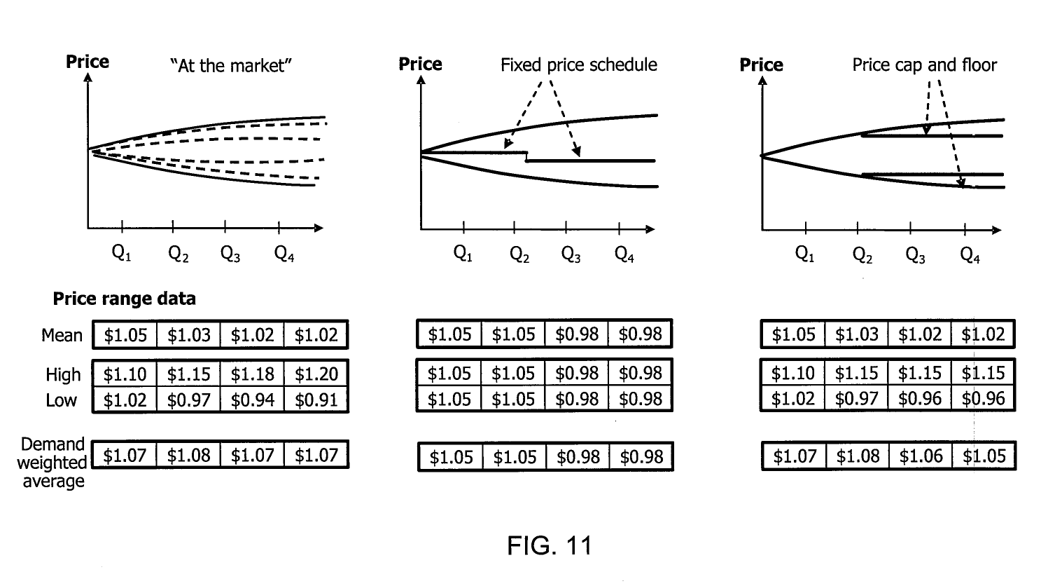

FIG. 11 is a representation of system output that shows an example analysis of the impact of two prospective sets of rights and obligations for the price terms of a CPD that are defined based on the probability distribution for the uncertain future price of a good. The chart on the left in FIG. 11, and the table below it, show the probability distribution for the uncertain future price of the good. The graphic in the middle, and the table below it, show the performance of CPD price terms that give the buyer the right to buy at a fixed price of $1.05 during Q1 and Q2, and at $0.98 during Q3 and Q4 if the future price is at or above those price levels during the relevant time period, and the obligation to buy at those prices if the future price is below those levels during the relevant time period. The graphic on the right, and the table below it, show the performance of CPD price terms which give the buyer the right to buy at a fixed price of $1.15 during Q3 and Q4 if the future price is at or above that level during those time periods, and the obligation to buy at $0.96 during the same time periods if the future price during those periods is below that level.

As a second example, the system may also recommend penalties or incentives which should be included in a CPD's terms to ensure that the CPD's one or more counterparties perform to the rights and obligations of the CPD. As in the example above, these CPD terms may be determined by utilizing the analysis capabilities described in Section II, specifically the methods described in subsections C, D, and E of Section II for determining the impact of CPD terms on a counterparty, and likely counterparty actions under a CPD.

As a third example, rights and obligations generated by the system based on analysis of the SPFE of the CPD and/or probability distributions of relevant variables, as described above, may be further refined based on analysis of their impact on related operational activities. For example, a user may wish to augment the policies for setting rights and obligations for purchase quantities under a CPD based on percentiles of its future demand distribution with criteria based on the cost or liability of such policies. For instance, in the example above, where an obligation is created to purchase a quantity of a product or service equal to the tenth (10th) percentile of the probability distribution of future demand, and a right to purchase additional quantity of the product or service up to the 90th percentile of future demand, a user may wish to specify further criteria for increasing or decreasing such percentile values based on calculated values of their impact on inventory levels, cost levels, and the like.

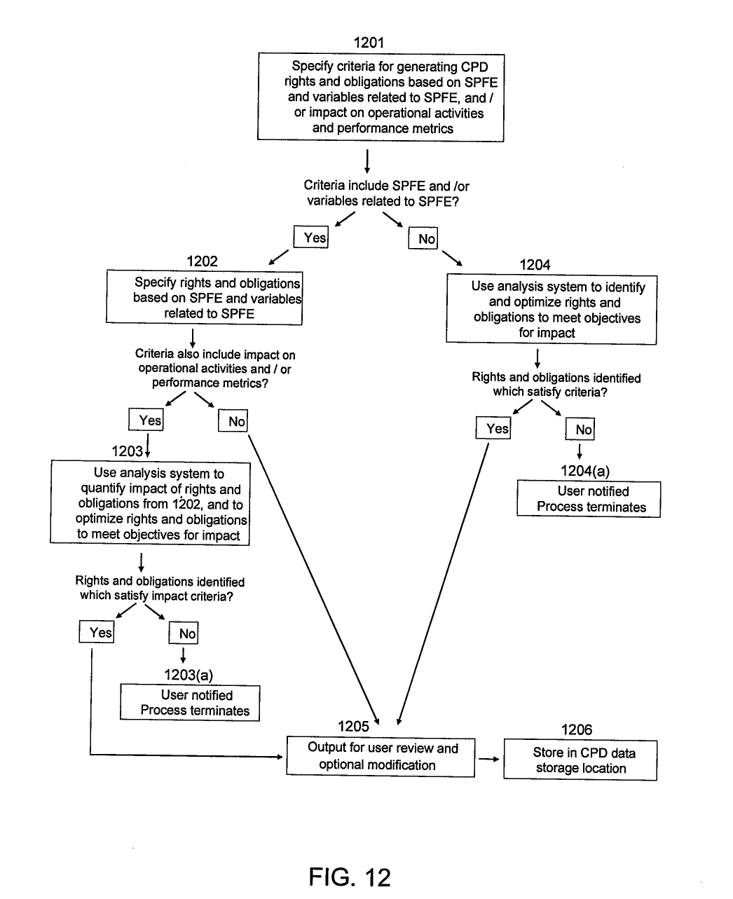

The system operation is shown in FIG. 12. In step 1201 the user specifies criteria for the rights and obligations to be generated. Following the discussion and examples above, criteria may be specified in terms of either or both 1) one or more of the variables used to define the SPFE of the CPD, and/or other sources of uncertainty related to the operational activities addressed by the CPD, or 2) variables related to the operational impact of the CPD, including operational activities, other CPD, counterparty relationships, or performance metrics. Consistent with the examples above, in many cases the user may wish to specify criteria based on the probability distribution of one or more such variables, and/or combinations or functions of two or more such variables.

If the criteria in step 1201 include specifications in terms of variables used to define the SPFE of the CPD and/or related sources of uncertainty, then in step 1202 these criteria are applied to the relevant variables and rights and obligations based on the specified criteria and the values of the variables are generated.

If the criteria in step 1201 are only specified in terms of variables used to define the SPFE of the CPD and/or related sources of uncertainty, then the rights and obligation generated in step 1202 are output to optional step 1205 for user review and approval, and if found to be satisfactory are sent to step 1206 for storage in the CPD data storage location.

If the criteria in step 1201 also include variables related to the impact of the CPD, then the rights and obligations generated in step 1202 are sent to step 1203. In step 1203 the impact of the rights and obligations is quantified using one of the systems from subsections A-E of Section II above for quantifying the impact of CPDs. Choice of a specific system is based on the scope of operational impact which must be quantified and the organizational affiliation of the user, in light of the respective capabilities of the systems as described in Section II. If the quantified impact of the rights and obligations satisfy the criteria from step 1201 for variables related to the operational impact of the rights and obligations, the rights and obligations are output to optional step 1205 for user review and approval, and if found to be satisfactory sent from there to step 1206 for storage in the CPD data storage location. If the criteria are not satisfied, search algorithms or related optimization methods are utilized with the relevant system from subsections A-E of Section II to identify rights and obligations which do meet the criteria. If such rights and obligations are identified, they are output to optional step 1205 for user review and approval, and then to step 1206 for storage in the CPD data storage location. If no such rights and obligations are found, in step 1203(a) the user is notified and the process terminates.

If the criteria in step 1201 are only specified in terms of variables related to the operational impact of the CPD, in step 1204 these criteria are utilized in an appropriate system from subsections A-E of Section II above (as described in step 1203), together with search algorithms or related optimization methods, to identify rights and obligations which satisfy the criteria. If such rights and obligations are identified, they are output to optional step 1205 for user review and approval, and then to step 1206 for storage in the CPD data storage location. If no such rights and obligations are found, in step 1204(a) the user is notified and the process terminates.

In step 1205 users may review the rights and obligations generated, and/or their impact on relevant operational activities, other CPDs, counterparty relationships, and/or performance metrics. If the review is satisfactory, the rights and obligations are output to step 1206 for storage in the CPD data storage location. If the user identifies areas of concern or opportunities for improvement, the user may modify the rights and obligations directly and then output them to step 1206, or may eliminate, revise, or augment one or more of the criteria specified in step 1201 and repeat the process (e.g. step 1202, 1203, or 1204) based on the updated criteria.

Recommendation of Both SPFEs and Rights and Obligations

The system may also recommend both the SPFE and the rights and obligations of a CPD. This may be done by combining the methods described above for recommending the SPFE and the rights and obligations of a CPD. Alternatively, it may be accomplished using user-specified policies or templates for setting CPD terms based on the operational activities to be addressed by a CPD, on characteristics of one or more of the counterparties of a CPD, on performance objectives for a CPD, or a combination thereof.

For example, a user may wish to employ similar CPD terms for all CPDs used for particular operational activities, such as the purchase, manufacture, or sale of a particular product or service, or categories thereof. Alternatively, the user may wish to standardize CPD terms across all CPDs with a particular counterparty, or across categories of counterparties (e.g. all suppliers of a particular product or service, all suppliers in a particular geographic region, or all suppliers of products or services valued in excess of a minimum dollar amount). Implementation of such user-specified policies may be accomplished through system-based search for user-specified CPD terms for the specific operational activities and/or counterparties of a prospective CPD.

As a second example, a user may wish to utilize terms for CPDs for particular operational activities and/or counterparties which are similar to the terms of CPDs which have been used previously for such activities or counterparties, or for other operational activities or counterparties specified by the user. In this case, after identifying the operational activities related to and/or the one or more counterparties of a prospective CPD, the system will search for current or previous CPDs which satisfy the user-specified criteria, and generate CPD terms for the prospective CPD similar to the terms of the CPDs identified. The system may alert the user to the CPDs it has identified as most similar, the criteria on which this identification is based, and other pertinent information.

As a third example, a user may wish to employ similar CPD terms for all CPDs with particular performance objectives, such as high service level, low liability exposure, minimum cost risk, etc. In this case, when a new CPD with a specified performance objective is requested, the system generates appropriate CPD terms utilizing stored values of CPD terms designed to achieve the specified performance objective.

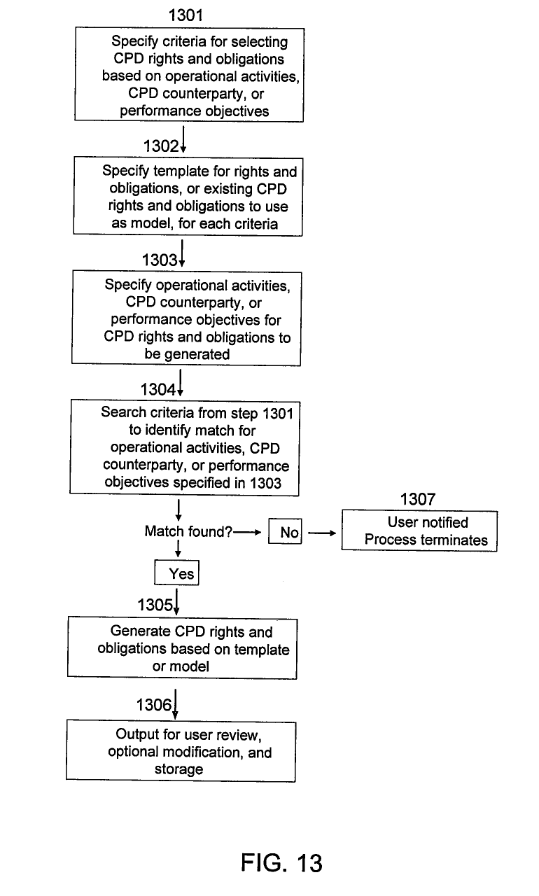

The system operation is shown in FIG. 13. In step 1301 the user specifies the criteria for selecting CPD rights and obligations, e.g. operational activities addressed, CPD counterparty, performance objectives, or a combination thereof. In step 1302 the user specifies a template for CPD rights and obligations, or identifies rights and obligations of current or previous CPDs, as the case may be, to be used for CPDs which meet the criteria specified in step 1301. In step 1303 the user specifies the operational activities, one or more counterparties, and/or performance objective for a CPD for which it would like the system to generate rights and obligations. In step 1304 the system searches the criteria specified in step 1301 for a match with the information entered in step 1303. If an appropriate criterion is found, in step 1305 the CPD rights and obligations are generated for the CPD using the template or current or previous CPD terms for the criterion, as specified in step 1302. In step 1306 CPD rights and obligations are output for user review, optional modification, and storage in the CPD data storage location. If no relevant criteria are found, in step 1307 the user is notified and the process terminates.

C. Systems for CPD Execution and Monitoring Over Time

After a CPD has been established, each of its counterparties must take actions over time which are consistent with that counterparty's rights and obligations under the events from the SPFE of the CPD which occur over time. Each counterparty must also ensure that its one or more counterparties under the CPD execute in a manner consistent with its rights and obligations over time.

To support these activities over time a system may provide the following capabilities: 1) identify the currently prevailing event from the SPFE of a CPD, 2) determine the rights and obligations of each counterparty of the CPD under the currently prevailing event, 3) recommend actions for one or more of the CPD counterparties, given that counterparty's rights and obligations under the current event, 4) facilitate execution of the recommended actions through integration with relevant transaction or counterparty collaboration systems, or other similar means, and 5) monitor the actions of the one or more other CPD counterparties to ensure the actions are consistent with its rights and obligations under the current event, and to enforce appropriate rights and obligations if required. Each of these system capabilities are described in more detail below.

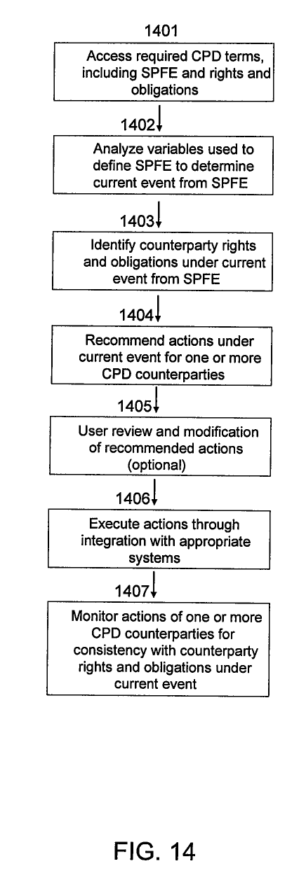

FIG. 14 shows operations of a system that provides the capabilities. In step 1401 the system accesses the terms of a CPD, including both its SPFE and its rights and obligations. The information is extracted from the databases or enterprise systems where it is stored, for example the locations specified in the systems described in subsections A-E of section II above.

In step 1402, the terms of the SPFE are reviewed to determine the variables which identify the current event from the SPFE, and the values of the relevant variables are extracted from appropriate data sources. For example, for the CPD shown in Table 1 above, the relevant variables are the current supply input price and the current level of customer demand. As a second example, if the SPFE of the CPD is defined implicitly, relevant variables may include counterparty actions under the CPD.

In step 1403 the rights and obligations of the CPD counterparties under the current event are identified. As in step 1401, this information is extracted from the databases or enterprise systems where it is stored, for example the locations specified in the systems described in subsections A-E of section II above. In the CPD shown in Table 1, the rights and obligations under the current event are the rights and obligations shown in the table entry which corresponds to the currently prevailing supply input price and customer demand level.

In step 1404 the system recommends actions for one or more CPD counterparties. The actions must be consistent with that counterparty's rights and obligations under the current event, as identified in steps 1401-1403, and with the counterparty's objectives for the impact of the actions. To determine the actions, the system may draw on an appropriate system from subsections A-E of section II above, and run the analysis engine of the selected system using current values for the input variables of the system, as specified above. After the analysis engine output is generated, the portion of the output that specifies the actions to be taken under the current event is extracted by the present system.

In optional step 1405 recommended actions are reviewed by users. Users may wish to review recommended actions prior to their execution in order to assess their suitability, and/or to gain awareness of current activity under the CPD. Alternatively, the system may be configured to notify users of recommended actions only if the actions meet user-specified criteria. For example, users may wish to be notified of actions at the minimum, maximum, or other extreme point of the range of actions allowed under their rights and obligations under the CPD. In cases where recommended actions are sought for more than one counterparty of a CPD, and where one of the systems of subsections D or E of Section II is run to generate those recommended actions, the present system may include permissions and access control to limit access to the recommended actions to specified users, or to members of particular organizational entities.

After suitable review of the recommended actions, and modification where appropriate, in step 1406 the actions are executed by the system through integration with appropriate transaction or counterparty collaboration systems, or other similar means. In cases where two or more of the counterparties of a CPD are organizational entities within the same firm, the system itself may be used to communicate the actions between counterparties, and/or may serve as system of record for the actions.

In step 1407 users monitor the actions of their one or more counterparties under the CPD to assess whether the counterparty's actions under the current event are consistent with its rights and obligations under the event. To support this activity, the system extracts the counterparty's rights and obligations under the current event from the CPD data storage location, as described in step 1401, and extracts the counterparty's actions under the current event from the relevant transaction or counterparty collaboration systems, data storage locations, or from the present system, as the case may be, as described in step 1406. The counterparty's actions are compared with its rights and obligations under the current event, and if the counterparty's actions are not consistent with its rights and obligations, the system notifies one or more users, and/or to the relevant counterparty. The notice delineates the inconsistency, and if applicable references appropriate remedies as specified under the CPD. For example, the counterparty may have the option of changing its actions to make them consistent with its rights and obligations under the current event, or of accepting non-performance penalties specified under the CPD.

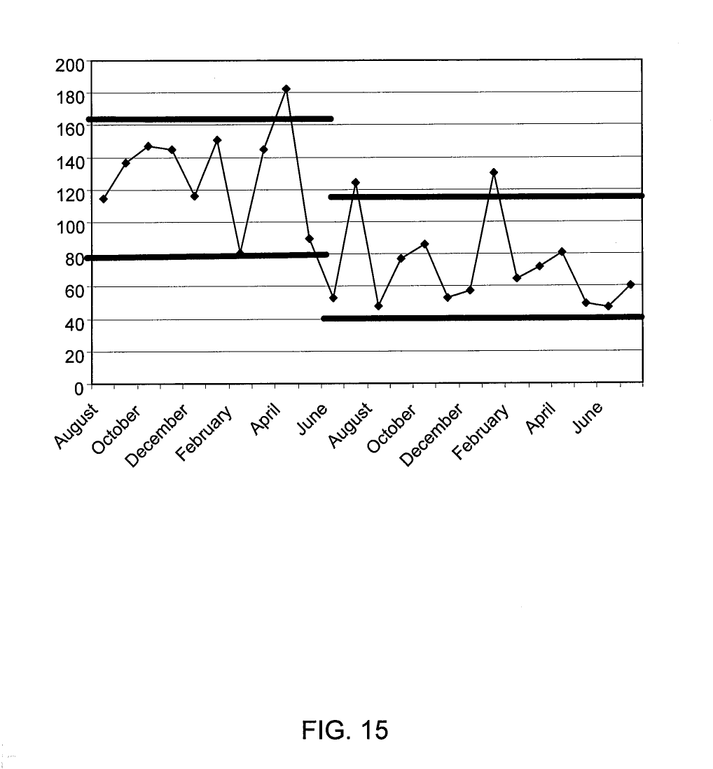

FIG. 15 shows a sample output produced by the system to facilitate a user's monitoring of counterparty actions under a CPD. In the chart in FIG. 15, the vertical axis shows quantity of the product managed with the CPD, and the horizontal axis shows time. The black line 1502 with data points for each month shows the quantity the counterparty has requested to purchase under the CPD over a series of recent months. The upper horizontal lines 1504 show the maximum quantity the counterparty may purchase each month, as specified by its rights under the CPD, while the lower horizontal lines 1506 show the minimum quantity the counterparty must purchase each month, as specified by its obligations under the CPD. As the chart in FIG. 15 shows, the quantity the counterparty requested exceeded the maximum value of its right during three of the months of the period shown.

D. Systems for CPD Modification and Updating Over Time

On-going changes in the operational activities, counterparties, performance objectives, business environment, and other circumstances of an organizational entity, as well as in those of its counterparties, create opportunities to increase value by adding, removing, and modifying CPDs over time. To benefit from such opportunities, organizational entities will ideally monitor for relevant changes and determine their implications for CPDs on a continuous or near-continuous basis.

Systems can help organizational entities conduct such monitoring, and also identify appropriate additions, deletions, or modifications of CPDs over time, as described below.

i. System to Add or Remove CPDs Over Time Based on Automated Monitoring of Changes in Operational Activities and Counterparty Relationships

The system described in subsection A above in this Section III may be used to monitor changes in operational activities and counterparties over time to identify opportunities to create value by adding or eliminating CPDs over time. Further, when an opportunity to create value by adding a CPD is identified, the system described in subsection B above in this Section III may be used to generate recommended terms for the proposed CPDs, including their SPFEs and/or their rights and obligations.

ii. System to Modify CPD Terms Over Time Based on Automated Generation and Evaluation of Alternative CPD Terms

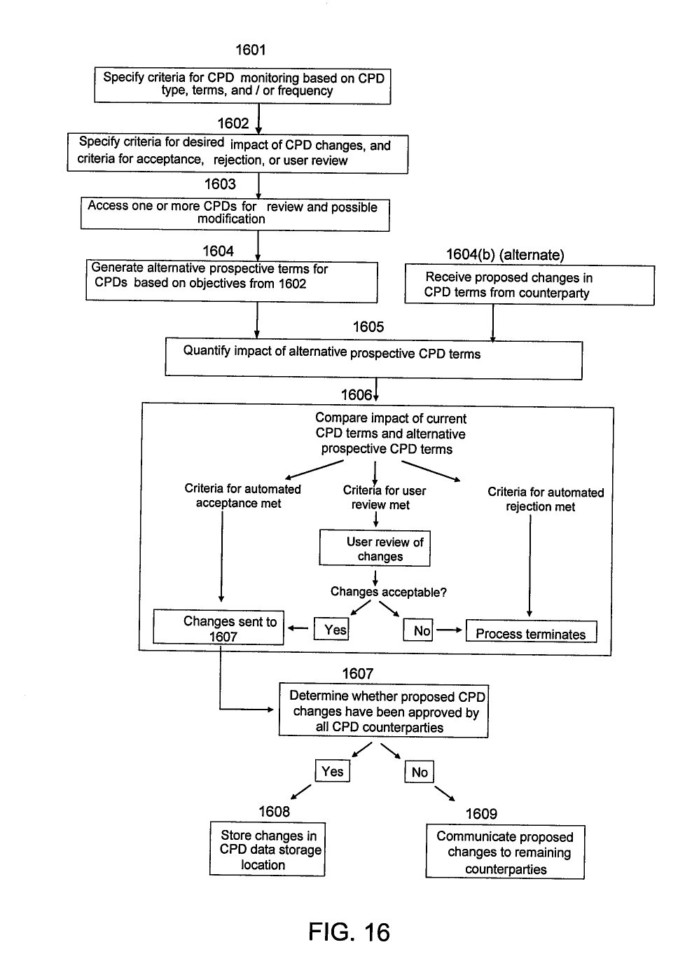

The system of Subsection B in Section III above may be utilized to construct a system to monitor for opportunities to create value through appropriate modification of the terms of currently existing CPDs over time. The operations of such a monitoring system are shown in FIG. 16.

In step 1601 the user specifies criteria for CPD monitoring. The criteria may include, but are not limited to, specification of (1) the CPDs or categories of CPDs to monitor over time, (2) types of changes in CPD terms to assess, e.g. changes in CPD SPFEs and/or CPD rights and obligations, (3) constraints on or other specifications for the changes in CPD terms proposed, and (4) frequency or timing of assessment.

In step 1602 the user specifies criteria for desired impact of the changes in CPD terms. The criteria may include nature and magnitude of impact on one or more operational activities, counterparty relationships, and/or performance metrics, of either one or two or more CPD counterparties. The user may further delineate criteria for the nature and magnitude of such impact which would cause the changes to qualify for automatic acceptance, rejection, and/or user review. All such criteria may be specified by type or category of CPD, CPD counterparty, or operational activities addressed.

In step 1603 the system accesses one or more CPDs for review and possible modification from the relevant data storage location, according to the CPD selection and monitoring criteria specified in step 1601. In step 1604 the system utilizes the system from subsection B, Section III to generate alternative prospective terms for the CPDs, given objectives from step 1602. In step 1605 the system utilizes one of the systems for quantification of the impact of CPDs from subsections A-E of Section II above to determine the impact of both the alternative prospective CPD terms and the impact of the current CPD terms, in each case for current values for the inputs to the relevant analysis system. The specific analysis system selected (e.g. system from subsection A, B, C, D, or E) will vary with the nature and scope of impact the user wishes to determine, e.g. impact on one or more organizational entities, etc.

In step 1606 the impact of the alternative prospective CPD terms is compared with the impact of the current CPD terms, and differences are assessed. User-specified criteria from step 1602 are applied to identify changes that meet criteria for automatic acceptance, rejection, and/or user review, as the case may be. Changes that meet criteria for automatic acceptance are sent directly to step 1607. Changes that meet criteria for automatic rejection cause the process to terminate. Changes that require user review are sent to step 1606b. Changes determined to be acceptable by the user in step 1606b are sent to step 1607, and changes which are rejected by the user cause the process to terminate.

In step 1607 appropriate actions are determined for changes which have been identified as acceptable. If the impact of the proposed changes in a CPD on all of the CPD's counterparties have been assessed and identified as acceptable to each such counterparty, in step 1608 the changes are recorded in the CPD data storage location. If the impact of the proposed CPD changes on one or more of the CPD's counterparties have not yet been assessed, for example if systems A, B, or C from Section II have been utilized in step 1605, the proposed change are communicated to such counterparties for their review in step 1609.

The system may also be configured to receive and assess proposed changes in CPD terms which have been generated by CPD counterparties, i.e. to receive and assess proposed changes such as those generated by the system in step 1609. In this case, the proposed changes are received in step 1604b, which replaces step 1604 as the source of proposed changes in CPD terms to be assessed by the system. The proposed changes are then evaluated and processed by the system in the usual way, through steps 1605-1608.

iii. System to Identify CPDs which May Benefit from Modification Based on Information from Execution and Monitoring Activities

Output from the execution and monitoring system shown in FIG. 14, and described in subsection C above, may be used to identify CPDs which may benefit from modification or updating. For example, as described above, the execution and monitoring system may be used to identify CPDs for which recommended actions have been at or near the extremes of the actions allowed under the rights and obligations of the CPD (e.g. minimum or maximum values). As a second example, the system may also be used to identify CPDs for which counterparties have failed to honor their rights and obligations under the CPD. As a third example, the system may be used to identify CPDs nearing maturity, or at a specified time interval from maturity, as candidates for updating and extension.

After such CPDs candidates for updating or modification have been identified, the system described in subsection B above in this Section III may be used to generate recommendations for appropriate terms for the CPDs, including either or both their SPFEs and/or their rights and obligations. After the recommended terms have been generated, they may be assessed using the system for automated evaluation of CPD terms described immediately above in subsection D (ii), and shown in FIG. 16.

iv. System to Identify CPDs for Addition, Deletion, or modification Based on Changes Over Time in the Impact of the CPDs on Operational Activities, Counterparty Relationships, and/or Performance Metrics

The systems for determining CPD impact presented in subsections A-E of Section II above may be used to construct a system for automatically calculating updated CPD impact over time based on changes in the values of the inputs to such systems. Such a system for automated updating of CPD impact may generate alerts and take actions based on user-specified criteria for changes in CPD impact over time.

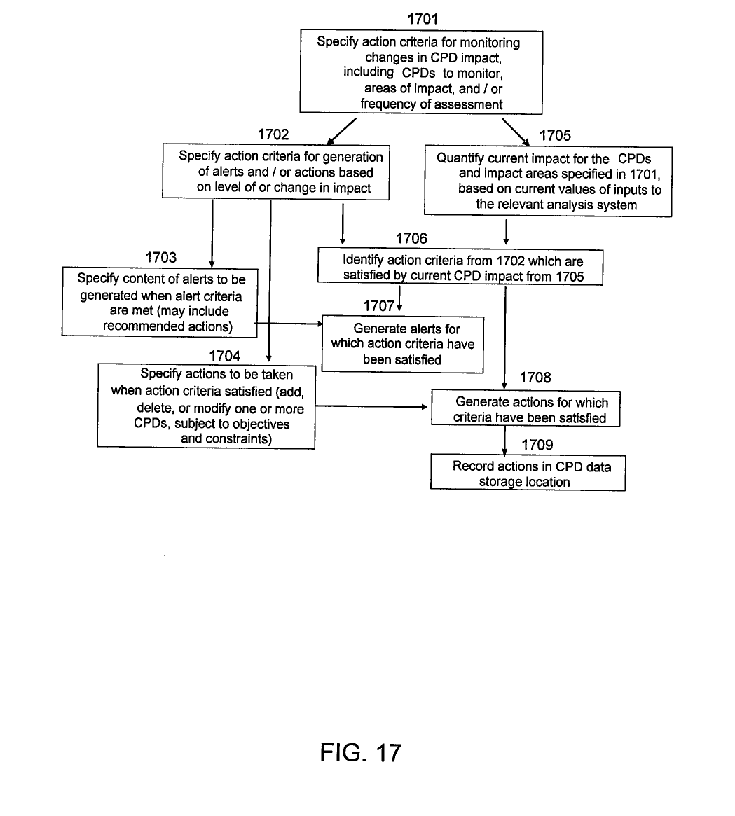

For example, the system may alert appropriate users if user-specified conditions for change in or level of particular areas of CPD impact occur over time. Such an alert may contain information about the change in CPD impact, identify CPDs related to the impact, assess underlying causes of the change in impact, and/or recommend appropriate actions, for example additions, deletions, or modifications of relevant CPDs. The system may also automatically implement actions which meet user-specified criteria, such as additions, deletions, or modifications of CPDs. The operation of a system with these capabilities is described below and shown in FIG. 17.

In step 1701 the user specifies criteria for monitoring changes in CPD impact. The criteria may include, but are not limited to, specification of 1) the CPDs, or categories of CPDs, whose impact is to be monitored, and 2) the areas of impact to monitor, for example impact on specified operational activities, counterparty relationships, and/or performance metrics of one or more organizational entities, and 3) the timing or frequency at which such changes in impact will be assessed.

In step 1702 the user specifies the criteria for desired system-generated alerts and actions. The criteria are defined in terms of the current level of or changes in variables which measure CPD impact, and may defined in terms of the value of individual such variables, or combinations or functions of such variables. Different criteria may be specified for each alert or action, and/or by type or category of CPD, CPD counterparty, and/or area of impact. The recipients for each alert may also be specified. To facilitate the specification of such criteria, templates may be created for commonly used criteria. Similarly, recipient groups and/or criteria for system-based generation of recipient lists for classes or categories of alerts or actions may also be created.

In step 1703 the user specifies the content of each alert. As described above, alert content may (1) provide information about the level of and/or change in relevant areas of impact, (2) identify CPDs related to the change in impact, (3) assess underlying causes of the change, and/or (4) provide other information that enables the user to understand the extent, causes, and consequences of the change. Alert content may further include recommended actions, such as the addition, modification, or deletion of one or more CPDs, or recommendations for further review of particular areas of impact, or for the review of the impact of one or more additional CPDs or groups or categories of CPDs.

In step 1704 the user specifies the system-generated actions which should be taken for each of the user-specified criteria for such system-generated actions specified in step 1702. Relevant types of actions include addition, deletion, or modification of one or more CPDs. Actions to modify a CPD may impact some or all of the CPD's terms, e.g. one or more elements of its SPFE and/or one or more of its rights and obligations. The user may further specify objectives for or constraints on the CPD modifications, e.g. area and type of impact of the modifications, acceptable types of rights and obligations, etc. If the actions include the addition or modification of one or more CPDs, the system from subsection B, Section III may be utilized to generate appropriate terms for the new or modified CPDs.

In step 1705 the system utilizes one of the systems for the quantification of impact of CPDs from subsections A-E of Section II above to determine the change in impact of CPDs which results from the updated values of the inputs to such system. The specific system from subsections A-E of Section II selected, and the operational activities and CPDs assessed by it, are determined based on the user-specified monitoring criteria defined in step 1701.

In step 1706 the CPD impact quantified in step 1705 is evaluated relative to the user-specified criteria for current level of or changes in variables which measure CPD impact from step 1702, and areas of CPD impact which meet criteria for generation of one or more alerts or system-generated actions are identified.

If criteria for generation of one or more alerts are met, in step 1707 relevant alerts are generated and sent to appropriate users, as specified in step 1702. In response to the alerts the users may take actions recommended by the alerts, if applicable.

If criteria for one or more system-generated actions are met, in step 1708 the appropriate actions, as specified in step 1704, are initiated by the system. Associated additions, deletions, and modifications of CPDs are recorded in the CPD data storage location in step 1709.

IV. Systems and Methods for Using the Techniques Described Herein

Most organizations produce, generate, and maintain documentation and all manner of communications with enterprise data systems, which are typically comprised of networked data storage computers in communication with many users at computer workstations. The users access the data and conduct communications through computers including desktop computers, laptop computers, and the like. Communications between users often occurs via email systems. The databases maintained by the computer network often include a vast amount of data such as operational data, inventory, marketing, personnel, and the like. The storage network typically operates under a storage network application, often under control of document management software.

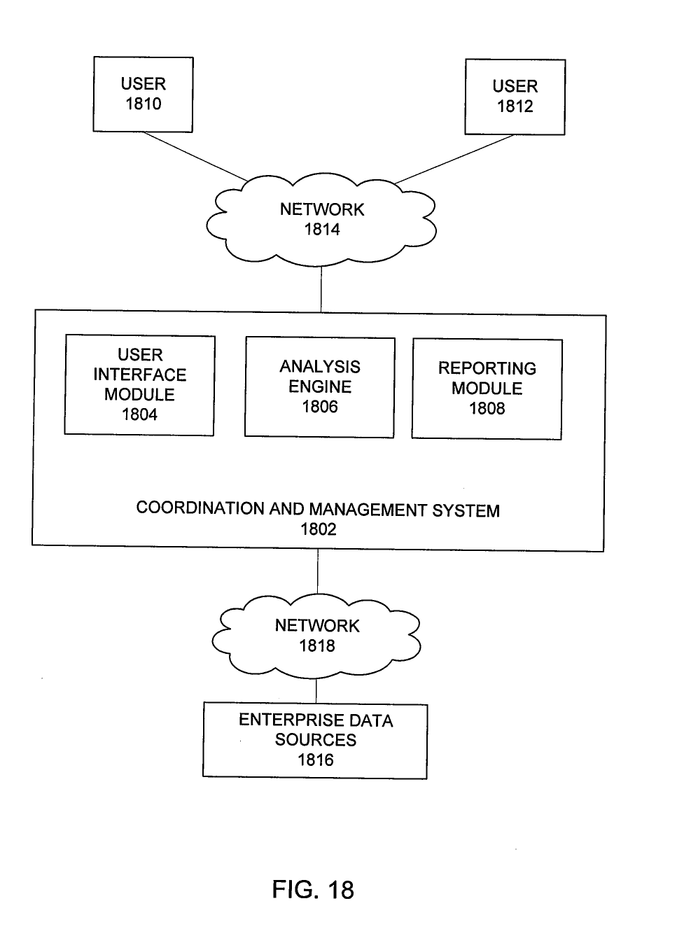

The operations described in the description above and illustrated in the operational illustrations can be performed by users communicating over computer networks utilizing enterprise data systems relating to operational information of the organizational entities whose operational activities are being coordinated and managed. An exemplary system that performs such operations is illustrated in FIG. 18.

FIG. 18 shows a Coordination and Management System 1802 constructed in accordance with the present invention. The system 1802 includes a user interface module 1804, analysis engine 1806, and reporting module 1808. The user interface module supports communication with users 1810, 1812 over a network connection 1814. The system can be implemented with processors such as conventional desktop computers, laptop computers, servers, and the like that are capable of performing the operations described herein. The users 1810, 1812 can communicate with the system over the network 1814 or can be connected directly to the computer implementing the coordination and management system 1802, such as by USB connection, wireless communication, and the like. The users 1810, 1812 may comprise individuals or each “user” may include one or more individuals comprising one of the parties to a CPD under discussion. The parties to a CPD may comprise individuals or entities within a single company or enterprise, or the parties may comprise a combination of internal and external entities relative to an enterprise. In this context, an individual comprises a single person, and an organizational entity comprises a functional or operational unit to which one or more individuals are assigned. A company or enterprise comprises multiple individuals whose efforts are expended on behalf of the enterprise. The individuals in the enterprise may be organized into one or more internal organizational entities. It should be apparent that an individual or organizational entity of one enterprise can participate in a CPD with an individual or organizational entity of a different (external) enterprise, or of the same enterprise (internal).

Although two users 1810, 1812 are illustrated in FIG. 18, it should be noted that each of the two users may comprise multiple individuals. Moreover, the illustration of two users is not intended to limit the system operation from what has been described above; to wit, the parties to a CPD are not limited to only two parties, but rather can include multiple parties, all with rights and obligations defined with respect to each other over a set of potential future events (SPFE) for the operational activities in question. That is, only two users 1810, 1812 are illustrated for simplicity of presentation and discussion only; the system 1802 can support multiple parties and users as described above. In addition, the system may support providing access to persons in addition to the parties (or representatives of the parties) to a CPD, including persons in other organizational entities and external firms. Further, management or supervisory personnel of an enterprise may be given access to CPDs and associated messages and documents, depending on administrative options that are selected during setup of the system. Such selections are entered via the user interface module 1804, which thereby performs an administration and management function.

The user interface module 1804 is the means through which the users 1810, 1812 can interact with the system. Information for each current or prospective CPD to be assessed may either be entered directly by the users through the user interface module, or may be uploaded from one or more existing locations, such as from one or more databases.

To generate a CPD, templates or default values may be used by the system 1802 to automatically generate an initial CPD, which may then be modified by the users. For example, a user might use the interface module 1804 to select a type of agreement or subject matter, from which the system generates a draft CPD, or a user might be identified as a particular category of participant or employee, from which the system generates a draft CPD. The draft CPD will be populated with default values and one or more users can then modify and refine the CPD as appropriate. In one instance, a sponsoring enterprise that provides the system 1802 may prearrange templates and default CPD parameters to help parties to the CPD in carrying out the process for creating the CPD.

The user interface module 1804 can comprise a software application that manages the user-to-user communication and facilitates the creation of a CPD. The module may facilitate such communications by providing a message forum or other means of storing, retrieving, and sharing messages between users of the system. The module may solicit information concerning the operational activities of one or more relevant organizational entities, including counterparty relationships. That is, the module may generate messages to users that request information needed for producing or modifying a CPD, or assessing the impact of a CPD, for example by generating on-screen queries in real time (i.e., wait for response) while a user is interacting with the system in connection with a CPD. The operational activities of the organizational entities involved, including counterparty relationships where CPDs are not in place, may be modeled with methods commonly used in current practice. The module 1804 may also facilitate user access to other current and prospective CPDs of the organizational entities.

In addition to receiving information from users, the operational modeling and related information may be automatically obtained by the user interface module 1804 via data maintained by the system 1802 or the module may have access to enterprise data sources 1816 over a data network 1818. The data network 1818 can comprise the same network 1814 over which the users 1810, 1812 communicate with the System 1802, or the data network 1818 can comprise a different network with access control and security as desired. The enterprise data sources 1816 can comprise databases that contain the enterprise operational information needed to operate with the CPDs as described herein. Such data sources may include, for example, data applications management systems such as provided by Oracle, Inc. and SAP AG and related systems, such as enterprise resource planning systems and the like. The enterprise data sources 1816 may include systems at a single company or organizational entity, or may include systems from multiple companies and organizational entities. The data may include a wide variety of enterprise data, such as data relating to sourcing, inventory, production and distribution of products, engineering, product management, sales and marketing operations, administration, and human resources. Thus, the user interface module 1802 may include a component for retrieving data from enterprise databases, such as from relational database management systems, and may include a component for data conversion or message processing or other processing necessary to permit operations on the retrieved data by the system 1802 in accordance with this description.

Once the users 1810, 1812 have established terms of one or more current or prospective CPD, the analysis engine 1806 evaluates the likely impact of the terms of such one or more current or prospective CPDs on the operational activities of interest, including counterparty relationships where CPDs are not in place, and on any other current or prospective CPDs desired. The impact on performance metrics related to such operational activities and CPDs may also be evaluated. One technique that may be used for completing the required analysis is described in U.S. Provisional Application “Method for managing operational activities when Contingent Performance Deliverables are in Place” by Blake Johnson filed concurrently with this application. Other techniques for carrying out the analysis of operational impact and performance impact may occur to those skilled in the art.

The analysis engine 1806 determines the likely impact of the one or more CPDs under discussion on the operational activities of the one or more organizational entities, including counterparty relationships where CPDs are not in place, and/or on other current and prospective CPDs of the one or more organizational entities. The analysis engine may provide output that comprises an evaluation of the likely result of the specified rights and obligations of the parties to the CPDs on one or more performance metrics of the organizational entities, in place of or in addition to evaluating the likely impact or result on the operational activities. The system 1802 may provide data on the operational impact through data tables, such as spreadsheets, as well as through more visual means, such as graphs and charts. The analysis engine 1806 may be used to help formulate a CPD in accordance with the output. For example, the data from which the CPD is to be produced (in terms of rights and obligations, SPFE, and operational activities specified by the CPD) may be determined by the analysis engine output using initial default or specified parameters comprising a draft CPD. The determined data output comprising an evaluation of the likely impact of the draft CPD may then be used to generate a next-iteration version of the CPD. The next-iteration version may then be shared with one or more of the parties to the CPD, which may result in further discussion and negotiation. After one or more such iterations, the CPD may be placed into a final form. Such data interaction may be facilitated or performed by the reporting module 1808.

It should be noted that the system 1802 may be used for updates to CPDs, so that changing situations (and/or more relevant or accurate data) may be used to update the CPD information. Such options in maintaining and using the CPD may be specified through the user interface module 1802. Thus, the system may be used to iteratively carry on a negotiation and discussion process between the parties to a CPD, utilizing the likely impact evaluation of the analysis engine to refine the terms of the CPD until agreement on an update to a CPD is reached.

The set of likely results produced by the analysis engine 1806 may be provided in an interactive fashion, in real time, or the results may be communicated in a report document in addition to or in place of an interactive real-time reporting. The user interface module 1804 will automatically establish communication with the analysis engine 1806 and provide the data needed by the analysis engine, in the format necessary, without intervention by the users. The results produced by the analysis engine 1806 are received by the reporting module 1808. The reporting module produces a report according to a report format. The report format may be specified by an authorized user through the interface module 1802; the authorized user who specifies the report format may or may not be one of the parties to the CPD in question. Interactive reporting from the reporting module may be provided via an enterprise Intranet or the like, such as a Web application or other display software that can provide output such as email messages or blog posts or Web pages to the computers operated by the respective users. The reporting module can format and deliver report documents by using a desktop publishing facility or similar publishing software to disseminate text and graphical information to the users via network communications. In this way, manual intervention and the labor associated with arranging raw data into a conventional report document using desktop publishing techniques are not needed.

Thus, a sponsoring organization such as a company or other enterprise may want to specify the desired report format through an authorized user via the interface module. The interface module may be used to specify availability of the report. That is, access to the report of the analysis engine results may be restricted to designated parties or users. In this way, the report might be designated for enterprise management only, or for the CPD parties only, just one CPD party or another, particular organizational entities that are not parties to the CPD, or some combination of users. If the users 1810, 1812 have access to the report of the analysis results from the analysis engine 1806, they may use the reported results to further refine and reach agreement on a CPD under discussion. Thus, a final version of the CPD in question may be agreed to by the parties after iterative discussions and negotiations over CPD terms based on output from the analysis engine and reporting module.

The analysis engine 1806 can be used to update or monitor CPDs that have been previously agreed upon by the users 1810, 1812. That is, the user interface module 1804 can be used to retrieve one or more existing CPDs and the analysis engine can evaluate the impact of an addition, deletion, or modification of the one or more CPDs on one or more performance metrics for the operational activities specified in the CPDs. The analysis engine also can evaluate the likely impact of such changes on the operational activities, including relevant counterparty relationships where CPDs are not in place and other relevant current or prospective CPDs. A user who retrieves a CPD for analysis can specify such operations through appropriate input when initiating an analysis. The analysis engine will automatically consult the appropriate local storage or enterprise data sources to perform the analysis. In a similar way the system may automatically recommend CPDs for addition, deletion, or modification based on impact on operational activities or performance metrics over relevant sources of uncertainty, according to user specified criteria. The system may further recommend specific rights and obligations of CPDs, and SPFEs of CPDs, based on similar analysis and user-specified criteria. Identification of CPDs for addition, deletion, or modification may be based on changes in inputs to the analysis engine over time, such as circumstances and objectives related to operational activities or counterparty relationships, sources of uncertainty, counterparty actions, or other related variables.

As noted above, the output of the analysis engine 1806 may be produced by the reporting module 1808 so as to provide summary data on the impact of the one or more CPDs on a broad range of operational activities, or about their impact on specific operational activities of particular relevance to individual users within an organizational entity, such as users responsible for those specific activities. The analysis engine output also may provide data on the likely impact of the CPDs on an organizational entity's overall set of other current or prospective CPDs, or on specific CPDs of interest to particular users.

The reporting module 1808 can generate reports on each area of operational impact to convey the likely impact of the CPDs under different events of, or subsets of events of, the SPFEs of one or more CPDs. Reports of this kind allow the likely impact of the rights and obligations of the CPDs under specific events or subsets of events to be quantified and analyzed, and therefore further optimized to provide the greatest benefit. The reporting module also may generate reports of the likely impact of the CPDs across outcomes of other relevant sources of uncertainty. This information can be used to select the structure and terms of CPDs to optimize that impact, including the risk and flexibility of operational activities.

The reporting module 1808 receives the analysis engine 1806 output and is adapted to produce summary reports. These reports can be configured to provide summary data on the likely impact of one or more CPDs on a broad range of operational activities, or about the likely impact of the CPDs on specific operational activities of particular relevance to individual users within the organizational entity, such as users responsible for those specific operational activities. Similarly, the reporting module may produce reports configured to provide data on the likely impact of the CPDs on the organizational entity's overall set of other current or prospective CPDs, or on specific CPDs of interest to particular users. A user of the system 1802 can request one or more reports and can specify the nature of data to be reported and the presentation format. The reporting module can automatically request and obtain access to data, such as enterprise data sources, necessary to produce the requested reports. The reporting module also can produce a report containing data that is configured for use by the user interface module to generate a draft or revised CPD.

The reporting module 1808 permits tailoring the reports generated to reflect the characteristics of the CPDs being assessed, and to the business purpose of the reports, including the role and sophistication of their intended audience. That is, the reporting requirements of different organizational entities will in general differ as to details, topics, metrics, and the like, due to differences in their activities and objectives, and the reporting module will provide an interface through which the parties may tailor the output. The reporting module may restrict such tailoring to users who have authorization to do so, such as through a setup operation. The report tailoring may occur at setup of an installation of the system, or the tailoring may occur on a CPD-by-CPD basis.

The user interface module 1804, analysis engine 1806, and reporting module 1808 have been described above as independent components of the Coordination and Management System 1802. These components, however, may be provided as separate and distinct processing units, each implemented with separate dedicated processors or computers, or the components may comprise modules of one or more software processes that execute within the operating system of a single processor or computer. Nevertheless, the functional distinctions described above for each of the modules 1804, 1806, 1808 may be used to describe the operation and processing of the system 1802.

V. Related Current Practices and Relevant Literature

While CPDs are not currently used for operational coordination within firms, in recent years they have begun to be used to a limit extent between firms. These activities and relevant literature are described below, and the important differences between them and the invention disclosed are summarized.

Operational Coordination Between Firms

As described above, in addition to the challenges firms face in coordinating complex internal operational activities, firms also face challenges in coordinating operational activities with external business partners, such as their customers, suppliers, and manufacturing, IT, and logistics services providers, as discussed above.

To facilitate coordination with external partners, in recent years some firms have begun to adopt methods of structuring and managing relationships with external partners. For a general review of academic research on the use of contracts in supply chain relationships between firms, see for example Cachon, G., “Supply chain coordination with contracts,” Handbooks in Operations Research and Management Science: Supply Chain Management. Steve Graves and Ton de Kok, editors, North Holland, 2003. An explanation of how and why firms may choose to use contingent performance commitments in their relationships with other companies can be found, for example, in Johnson, B., “Conceptual and Methodological Differences in Quantifying and Managing ‘Commoditized’ and ‘Non-Commoditized Risks’”, Conference on Integrated Risk Management, Washington University, St. Louis, Mo., June 2004. Descriptions of activities of early adopters of this approach are provided in Van Dam, C., “Supply risk and flexibility management at Agilent”, Parallax View, June 2004, in Vaidyanathan, V., D. Metcalf, and D. Martin, “Using Capacity Options to Better Enable Our Factory Ramps,” Intel Technology Journal, Vol. 9, Issue 3, pp. 185-191, and in Johnson, B., “Optimizing Tool Availability and Lead Time with Procurement Options”, Proceedings of the Thirteenth Annual International Symposium on Semiconductor Manufacturing, San Jose, Calif., September 2005. Capabilities to support buyers in their structuring and analysis of agreements with suppliers are described in U.S. patent application Ser. No. 10/269,794 “System and method for automated analysis of sourcing agreements and performance” (available via the online Patent Application Information Retrieval (PAIR) system of the U.S. Patent and Trademark Office) and in Martinez de Albeniz, V. and D. Simchi-Levi, “Mean-Variance Trade-offs in Supply Contracts”, Naval Research Logistics, Vol. 53, pp. 603-616.

All of the research and practical examples cited above are limited by the fact that they only address relationships with external companies, and for a given company only address its relationships with one or more suppliers, or with one or more customers. Thus they do not address relationships between organizational entities within the same firm, or the simultaneous use of relationships for both “inputs” and “outputs”, whether with other internal organizational entities or external parties. As such, they do not provide methods to quantify the impact of the structure and terms of prospective relationships on relevant operational activities or other relationships, capabilities which are essential to efficiently and effectively identifying relationships that best meet business objectives.

In contrast, the systems and methods disclosed here enable organizational entities within a company to efficiently and effectively use CPDs, including their use with both other organizational entities within the same company and with external parties, and their simultaneous use for any combination of “inputs” and “outputs”. In addition, the systems and methods disclosed herein enable organizational entities to quantify the impact of the structure and terms of CPDs, and of groups of CPDs, on relevant performance metrics, operational activities, and other counterparty relationships, including both relationships governed by CPDs and relationships not governed by CPDs. This impact can be quantified for a single organizational entity, two or more organizational entities, or for specific operational activities. Further, the systems and methods disclosed here enable these capabilities to be made available both to the organizational entities responsible for the operational activities and relationships assessed, and to other organizational entities within the firm and external parties, with user-definable limitations. Finally, systems and methods are disclosed that enable CPDs to be updated and dynamically managed, utilized, and monitored over time in response to the arrival of new information, changing circumstances and objectives, counterparty actions, and the outcome of uncertain events, among other factors.

Collaboration Patents

A number of patents exist that describe techniques for facilitating collaboration, both within firms and between firms. Some examples include Button et al., U.S. Pat. No. 7,031,929; Brathwaite et al., No. 7,134,096; Notani et al., No. 7,039,597; Notani et al., No. 6,397,191; Notani et al., No. 6,332,155; Notani No. 6,119,149; Frees et al., No. 6,769,013; Cohen et al., No. 6,507,845; Hogge et al., No. 5,983,194. None of the collaboration techniques in these patents describe or utilize CPDs, or provide methods to enable the efficient and effective use of CPDs in collaborative activities, both within and between firms.

Other patents include Baseman et al., U.S. Pat. No. 6,671,673 which describes a method for improving business decisions by integrating financial management considerations in supply chain management decisions, and vice versa. The Baseman et al. patent describes incorporating financial management information, objectives, and techniques in supply chain management activities, and vice-versa, and therefore describes how financial management and supply chain management decisions can be integrated.

VI. Features

Thus, as described above, operational activities of an enterprise can be coordinated and managed across organizational entities by utilizing CPDs that specify a set of rights and obligations for two or more parties to the CPD with respect to operational activities of the parties to the CPD, wherein the rights and obligations are defined over a set of uncertain potential future events (SPFE). The CPD is processed to provide an output comprising an evaluation of likely result of the specified rights and obligations of the parties to the CPD with respect to operational activities of at least one organizational entity, and with respect to sources of uncertainty related to the operational activities. An output report is generated from the evaluation output.

The operational activities, rights and obligations, and SPFE sets can be defined in accordance with user input, default values, or probability distribution functions, or any combination. The system can access existing CPDs and other data stored in the computer system to obtain data for current CPDs being produced or to use as input functions for the current CPDs being produced. The evaluation output can comprise an evaluation of the likely result of the specified rights and obligations of the parties to the CPD on one or more performance metrics of at least one organizational entity.

The techniques described above can assist users in developing, negotiating, utilizing, monitoring, and updating CPDs related to operational activities of one or more organizational entities and external parties. These techniques provide a variety of features, some of which are listed below.
1. A method for coordinating and managing operational activities across organizational entities within a firm that utilizes one or more CPDs.
2. A system as in claim 1, wherein evaluation of likely result is also determined with respect sources of uncertainty related the operational activities of at least one party to the CPD.
3. A method for coordinating and managing operational activities that utilizes CPDs for one or more inputs and one or more outputs of the operational activities.
4. For methods 1-3, a method to evaluate the impact of the terms of one or more current or prospective CPDs of an organizational entity on the operational activities of, or other current or prospective CPDs of, the organizational entity.
5. For methods 1-3, a method to evaluate the impact of the terms of one or more current or prospective CPDs of an organizational entity on one or more performance metrics for the organizational entity.
6. The method of methods 4-5 for one organizational entity within a firm made available to one or more other organizational entities within the same firm, or to external parties.
7. A method to evaluate the impact of the terms of one or more current or prospective CPDs on the operational activities of, or other current or prospective CPDs of, two or more organizational entities within a firm.
8. A method to evaluate the impact of the terms of one or more current or prospective CPDs on one or more performance metrics for two or more organizational entities within a firm.
9. The method of methods 7-8 for two or more organizational entities within a firm made available to one or more other organizational entities within the same firm, or external parties.
10. A method to evaluate the impact of the terms of one or more current or prospective CPDs on the operational activities of, or on the current or prospective CPDs of, a firm which are relevant to specific operational activities of the firm.
11. A method to evaluate the impact of the terms of one or more current or prospective CPDs on one or more performance metrics for specific operational activities of the firm.
12. The method of methods 10-11 for specific operational activities within a firm made available to one or more other organizational entities within the same firm, or external parties.
13. A method for updating or dynamic management of individual CPDs or groups of CPDs based on the net impact of the updating or dynamic management of the CPDs on operational activities related to the CPDs, performance metrics for those operational activities, or current or prospective CPDs related to those activities, after actions taken to adapt to or accommodate the updating or dynamic management of the CPDs, including changes in related operational activities and changes to or additions or deletions of other related CPDs.
14. A method for automated generation of the SPFE or rights and obligations of a CPD based on probability distributions for relevant operational variables

The present invention has been described above in terms of presently preferred embodiments so that an understanding of the present invention can be conveyed. There are, however, many configurations for management systems not specifically described herein but with which the present invention is applicable. The present invention should therefore not be seen as limited to the particular embodiments described herein, but rather, it should be understood that the present invention has wide applicability with respect to management systems generally. All modifications, variations, or equivalent arrangements and implementations that are within the scope of the attached claims should therefore be considered within the scope of the invention.

I claim:

1. A computer system comprising:
a user interface module operable to produce a data record comprising a contingent performance deliverable (CPD) that specifies a set of rights and obligations for two or more parties to the CPD with respect to operational activities of the parties to the CPD, wherein the rights and obligations are defined over a set of uncertain potential future events (SPFE);
an analysis engine operable to provide an output comprising an evaluation of likely result of the specified rights and obligations of the parties to the CPD over the SPFE of the CPD with respect to operational activities of at least one organizational entity comprising an analysis entity, and with respect to sources of uncertainty related to the operational activities of at least one analysis entity; and
a reporting module operable to receive the analysis engine output and produce a report of the analysis engine output.

2. A system as in claim 1, wherein the sources of uncertainty are with respect to the operational activities of at least one party to the CPD.

3. A system as in claim 1, wherein one or more parties to the CPD are also analysis entities.

4. A system as in claim 1, wherein the user interface module receives input that specifies the SPFE for the CPD.

5. A system as in claim 1, wherein the user interface module receives input that specifies the rights and obligations of one or more parties to the CPD over the SPFE of the CPD.

6. A system as in claim 1, wherein the user interface module receives input that specifies one or more operational activities in which one or more analysis entities or parties to the CPD are engaged.

7. A system as in claim 6, wherein the user interface module receives input that specifies data records comprising other current CPDs or prospective CPDs relevant to the operational activities of one or more analysis entities or parties to the CPD.

8. A system as in claim 1, wherein the analysis engine obtains data from the data records comprising other current CPDs or prospective CPDs and performs the evaluation in accordance with the obtained data.

9. A system as in claim 1, wherein the system modifies a CPD in accordance with a report received from the reporting module.

10. A system as in claim 1, wherein the user interface module automatically determines data values associated with the CPD in accordance with system data sources.

11. A system as in claim 1, wherein the user interface module automatically determines data values associated with the CPD in accordance with an uncertainty level.

12. A system as in claim 1, wherein the analysis engine output comprises an evaluation of the likely result of the specified rights and obligations of the parties to the CPD on one or more performance metrics of at least one analysis entity.

13. A system as in claim 12, wherein the analysis engine performs the evaluation using data obtained from enterprise data sources.

14. A system as in claim 1, wherein the system generates a CPD in accordance with identification of the parties to the CPD.

15. A system as in claim 1, wherein the reporting module generates a report comprising a presentation of one or more inputs to the analysis engine.

16. A system as in claim 1, wherein the SPFE set is defined based on at least one probability distribution relating to operational activities of one or more analysis entities or parties to the CPD.

17. A system as in claim 1, wherein the rights and obligations are defined based on at least one probability distribution relating to operational activities of one or more analysis entities or parties to the CPD.

18. A system as in claim 1, wherein the user interface module determines one or more of the operational activities addressed by the CPD based on the level of uncertainty of the operational activities.

19. A system as in claim 1, wherein the user interface module obtains data for the CPD in response to identification of the parties to the CPD and in accordance with default values.

20. A system as in claim 19, wherein the user interface module obtains data for the CPD in response to identification of the parties to the CPD such that the user interface module identifies enterprise databases from which the data for the CPD can be obtained.

21. A system as in claim 1, wherein the user interface module determines the SPFE set over which the rights and obligations of the CPD parties are defined.

22. A system as in claim 1, wherein the user interface module determines the rights and obligations of the parties to the CPD.

23. A system as in claim 1, wherein the analysis engine output comprises recommended actions for one or more parties to the CPD under one or more events of the SPFE of the CPD.

24. A computer implemented method for managing operational activities of an enterprise, the method comprising:
producing a computer data record comprising a contingent performance deliverable (CPD) that specifies a set of rights and obligations for two or more parties to the CPD with respect to operational activities of the parties to the CPD, wherein the rights and obligations are defined over a set of uncertain potential future events (SPFE);
providing an output comprising an evaluation of likely result of the specified rights and obligations of the parties to the CPD over the SPFE of the CPD with respect to operational activities of at least one organizational entity comprising an analysis entity, and with respect to sources of uncertainty related to the operational activities of at least one analysis entity; and
producing a report in accordance with the evaluation of the output.

25. A computer implemented method as in claim 24, wherein the output comprises an evaluation of likely result of the specified rights and obligations of the parties to the CPD over the SPFE of the CPD with respect to operational activities of at least one organizational entity comprising an analysis entity, and with respect to sources of uncertainty related to the operational activities of at least one party to the CPD.

26. A method as in claim 24, wherein one or more parties to the CPD are also analysis entities.

27. A method as in claim 24, wherein producing the CPD comprises receiving input that specifies the SPFE for the CPD, the set of rights and obligations for the CPD, and one or more sets of operational activities in which one or more of the analysis entities or parties to the CPD are engaged.

28. A method as in claim 27, wherein the set of rights and obligations for the CPD are specified for one or more parties to the CPD over the SPFE of the CPD by default values.

29. A method as in claim 27, wherein one or more of the sets of operational activities are specified by a set of default values.

30. A method as in claim 27, wherein one or more of the sets of operational activities are specified by user input.

31. A method as in claim 24, further including receiving input that specifies computer data records comprising other current CPDs or prospective CPDs relevant to the operational activities of one or more of the analysis entities or parties to the CPD.

32. A method as in claim 31, further including obtaining data from the specified data records comprising current CPDs or prospective CPDs and performing the evaluation in accordance with the obtained data.

33. A method as in claim 24, further including modifying the CPD in accordance with a received output report.

34. A method as in claim 24, wherein data values associated with the CPD are automatically determined in accordance with an uncertainty level.

35. A method as in claim 24, wherein the output comprises an evaluation of the likely result of the specified rights and obligations of the parties to the CPD on one or more performance metrics of at least one analysis entity.

36. A method as in claim 24, wherein providing an output comprises performing an evaluation using data obtained from enterprise data sources.

37. A method as in claim 24, wherein a CPD is automatically generated in accordance with identification of the parties to the CPD.

38. A method as in claim 24, wherein a CPD is automatically modified in accordance with an output report.

39. A method as in claim 24, wherein the reporting module generates a report comprising a presentation of one or more inputs to the analysis engine, including but not limited to the SPFE of the CPD, rights and obligations of one or more of the parties to the CPD, operational activities related to one or more analysis entities or parties to the CPD, or sources of uncertainty related to such operational activities.

40. A method as in claim 24, wherein the SPFE set is defined based on at least one probability distribution relating to operational activities of one or more analysis entities or parties to the CPD.

41. A method as in claim 24, wherein the rights and obligations are defined based on at least one probability distribution relating to operational activities of one or more analysis entities or parties to the CPD.

42. A method as in claim 24, wherein one or more of the operational activities addressed by the CPD are determined based on the level of uncertainty of the operational activities.

43. A method as in claim 24, wherein producing a CPD data record comprises obtaining data for the CPD in accordance with identification of the parties to the CPD and in accordance with default values.

44. A method as in claim 24, wherein producing a CPD data record comprises obtaining data for the CPD in response to identification of the parties to the CPD such that the user interface module identifies enterprise databases from which the data can be obtained.

45. A method as in claim 24, wherein producing a CPD data record comprises determining the SPFE set over which the rights and obligations of the CPD parties are defined.

46. A method as in claim 24, wherein producing a CPD data record comprises determining the rights and obligations of the parties to the CPD.

47. A method as in claim 24, wherein the analysis engine output comprises recommended actions for one or more parties to the CPD under one or more events of the SPFE of the CPD.

48. A computer system comprising:
a user interface module operable to produce a data record comprising a contingent performance deliverable (CPD) that specifies a set of rights and obligations for two or more parties to the CPD with respect to operational activities of the parties to the CPD, wherein the rights and obligations are defined over a set of uncertain potential future events (SPFE) such that the SPFE set is defined based on at least one probability distribution function and wherein the user interface module receives input that specifies the rights and obligations of one or more parties to the CPD over the SPFE of the CPD;
an analysis engine operable to provide an output comprising an evaluation of likely result of the specified rights and obligations of the parties to the CPD over the SPFE of the CPD with respect to operational activities of at least one organizational entity comprising an analysis entity, and with respect to sources of uncertainty related to the operational activities of one or more analysis entities or parties to the CPD, wherein the output comprises an evaluation of the likely result of the specified rights and obligations of the parties to the CPD on one or more performance metrics of at least one analysis entity comprising a performance entity, using data obtained from enterprise data sources;
a reporting module operable to receive the analysis engine output and produce a report of the analysis engine output.

49. A system as in claim 48, wherein one or more parties to the CPD are also analysis entities.

50. A system as in claim 48, wherein the system generates a CPD in accordance with identification of the parties to the CPD.

51. A system as in claim 48, wherein the user interface module automatically determines data values associated with the CPD data record in accordance with an uncertainty level.

52. A system as in claim 48, wherein the user interface module receives input that specifies other current or prospective CPDs relevant to the operational activities of one or more analysis entities or parties to the CPD.

53. A system as in claim 48, wherein the analysis engine obtains data from the other specified current or prospective CPDs and performs the evaluation in accordance with the obtained data.

54. A system as in claim 48, wherein the system modifies a CPD document in accordance with a report received from the reporting module.

55. A system as in claim 48, wherein the reporting module generates a report comprising a presentation of one or more inputs to the analysis engine, including but not limited to the SPFE of the CPD, rights and obligations of one or more of the parties to the CPD, operational activities related to one or more analysis entities or parties to the CPD, or sources of uncertainty related to such operational activities.

56. A system as in claim 48, wherein the rights and obligations are defined based on at least one probability distribution relating to operational activities of one or more analysis entities or parties to the CPD.

57. A system as in claim 48, wherein the user interface module obtains data needed for the CPD in response to identification of the parties to the CPD such that the user interface module identifies enterprise databases from which the needed data can be obtained.

58. A system as in claim 48, wherein the user interface module determines one or more of the operational activities addressed by the CPD based on the level of uncertainty of the operational activities.

59. A system as in claim 48, wherein the user interface module obtains data for the CPD in accordance with response to identification of the parties to the CPD and in accordance with default values.

60. A system as in claim 48, wherein the user interface module obtains data for the CPD in response to identification of the parties to the CPD such that the user interface module identifies enterprise databases from which the data can be obtained.

61. A system as in claim 48, wherein the user interface module determines the SPFE set over which the rights and obligations of the CPD parties are defined.

62. A system as in claim 48, wherein the user interface module determines the rights and obligations of the parties to the CPD.

63. A system as in claim 48, wherein the analysis engine output comprises recommended actions for one or more parties to the CPD under one or more events of the SPFE of the CPD.

64. A computer implemented method for managing operational activities of an enterprise, the method comprising:
producing a plurality of data records each of which comprises a contingent performance deliverable (CPD) that specifies a set of rights and obligations for two or more parties to the CPD with respect to operational activities of the parties to the CPD, wherein the rights and obligations of each CPD are defined over a set of uncertain potential future events (SPFE) for that CPD such that the SPFE is defined based on at least one probability distribution function;
providing an output comprising an evaluation of likely result of the specified rights and obligations of the parties to the CPDs over the SPFEs of the CPDs with respect to operational activities of at least one organizational entity comprising an analysis entity, and with respect to sources of uncertainty related to the operational activities of one or more of the analysis entities or parties to CPDs, using data obtained from enterprise data sources;
producing a report in accordance with the evaluation of the output.

65. A method as in claim 64, wherein one or more parties to the CPD are also analysis entities.

66. A method as in claim 64, wherein the operational activities specified by one or more CPD data records are automatically specified by a set of default values.

67. A method as in claim 64, wherein the operational activities specified by one or more CPD data records are determined in accordance with an uncertainty level.

68. A method as in claim 64, wherein the operational activities specified by one or more CPDs data records are automatically specified in accordance with identification of the parties to the CPD.

69. A method as in claim 64, wherein the rights and obligations of one or more CPD data records are automatically specified in accordance with criteria based on the SPFEs of the CPD data record.

70. A method as in claim 64, wherein the rights and obligations of one or more CPD data records are determined based on probability distributions related to operational activities specified the CPD data record.

71. A method as in claim 64, further including:
accessing system data sources and retrieving data values associated with each CPD data record from the system data resources.

72. A computer system comprising:
a user interface module operable to access a data record comprising a contingent performance deliverable (CPD) that specifies a set of rights and obligations for two or more parties to the CPD with respect to operational activities of the parties to the CPD, wherein the rights and obligations are defined over a set of uncertain potential future events (SPFE);
an analysis engine operable to identify a current event of a CPD from the SPFE of the CPD.

73. A system as in claim 72, wherein the rights and obligations of one or more parties to the CPD under the current event are determined.

74. A system as in claim 72, wherein the actions of one or more parties to a CPD under the current event of the CPD are assessed to determine whether they are consistent with the respective CPD party's rights and obligations under the current event of the CPD.
